(19) United States
(12) Patent Application Publication
(10) Pub. No.: US 2016/0139453 A1
(43) Pub. Date: May 19, 2016

(54) DISPLAY APPARATUS

(71) Applicant: SHARP KABUSHIKI KAISHA, Osaka (JP)

(72) Inventors: Hideomi YUI, Osaka-shi (JP); Tsuyoshi MAEDA, Osaka-shi (JP); Emi YAMAMOTO, Osaka-shi (JP); Shohei KATSUTA, Osaka-shi (JP)

(21) Appl. No.: 14/898,150

(22) PCT Filed: Jun. 2, 2014
(86) PCT No.: PCT/JP2014/064642

§ 371 Date: Dec. 14, 2015

(30) Foreign Application Priority Data
Jun. 19, 2013 (JP) 2013-128321

(51) Int. Cl. G02F 1/1335; G02B 5/02

(52) U.S. Cl. CPC G02F 1/133504; G02B 5/0278; G02B 5/0257; G02B 5/0263; G02B 5/0221; G02B 5/0231

(57) ABSTRACT

A light diffusing member includes a base having light transmissivity, a light diffuser formed with a predetermined height on a surface of the base facing a display body, and a light blocking layer formed in a region other than the light diffuser on the surface of the base facing the display body. The light blocking layer has a thickness smaller than the height of the light diffuser. The light diffuser has a light exit end surface that is in contact with the base, and a light entrance end surface that is opposite the light exit end surface and that has an area larger than the area of the light exit end surface. The light entrance end surface is adhered to the adhesive layer, and the thickness of the adhesive layer is smaller than the height of a space formed between the light diffuser and the light blocking layer, the height extending from the light blocking layer to the light entrance end surface.

### TECHNICAL FIELD

The present invention relates to display apparatuses equipped with light diffusing members.

The present application claims priority based on Japanese Patent Application No. 2013-128321 filed in the Japan Patent Office on Jun. 19, 2013, the contents of which are hereby incorporated by reference.

### BACKGROUND ART

Liquid crystal display apparatuses are widely used as displays in, for example, portable electronic devices, such as portable telephones, television sets, and personal computers. A liquid crystal display apparatus normally has characteristics in which it has excellent viewability from the front but has a narrow viewing angle. Therefore, various designs have been attempted from the past for expanding the viewing angle of the liquid crystal display apparatus. One of the attempted designs involve disposing a light diffusing member at the viewing side of a liquid crystal panel (display body) and diffusing the light exiting from the viewing side of the liquid crystal panel by using this light diffusing member (for example, see Patent Literature 1).

Patent Literature 1 discloses a light diffusing sheet (light diffusing member) that has a light diffusing layer provided with grooves having a V-shape in cross section and that is provided with a light absorbing layer in a part of the grooves. In the light diffusing sheet, transparent sheets composed of, for example, polyethylene terephthalate (PET) are disposed at the light entrance side and the light exit side of the light diffusing layer. With this configuration, a portion of the light orthogonally entering the light diffusing layer from the light entrance side undergoes total reflection at the wall surfaces of the grooves and is subsequently output in a diffused state from the light exit side.

### CITATION LIST

### Patent Literature

PTL 1: Japanese Unexamined Patent Application Publication No. 2000-352608

### SUMMARY OF INVENTION

### Technical Problem

In order to cause the light to undergo total reflection at the wall surfaces of the grooves in the light diffusing sheet described above, it is desirable that the refractive-index difference at an interface between the inside and the outside of each groove be a large value. In the above-described light diffusing sheet, since a space (i.e., an air layer) exists between neighboring grooves, the refractive-index difference can be maximized between the transparent sheets, which are the high-refractive-index side, and the air layer, which is the low-refractive-index side.

However, when the light diffusing sheet is bonded to a liquid crystal panel, if an adhesive intrudes into the grooves, the refractive-index difference decreases at the interface between the wall surface of each groove and the adhesive. In this case, the light diffusing function of the light diffusing sheet deteriorates from that before the bonding process.

The present invention has been made in view of such circumstances in the related art, and an object thereof is to provide a display apparatus that suppresses deterioration of the light diffusing function of the light diffusing member when the light diffusing member is bonded to a display body via an adhesive layer.

### Solution to Problem

(1) A display apparatus according to an aspect of the present invention includes a display body, a light diffusing member that is provided at a viewing side of the display body and that outputs light in a state where angle distribution of the light entering from the display body is expanded relative to that before the light enters the light diffusing member, and an adhesive layer that is interposed between the display body and the light diffusing member. The light diffusing member includes a base having light transmissivity, a light diffuser formed with a predetermined height on a surface of the base facing the display body, and a light blocking layer formed in a region other than the light diffuser on the surface of the base facing the display body, the light blocking layer having a thickness smaller than the height of the light diffuser. The light diffuser has a light exit end surface that is in contact with the base, and a light entrance end surface that is opposite the light exit end surface and that has an area larger than an area of the light exit end surface. The light entrance end surface is adhered to the adhesive layer. A thickness of the adhesive layer is smaller than a height of a space formed between the light diffuser and the light blocking layer, the height extending from the light blocking layer to the light entrance end surface.

(2) A display apparatus according to another aspect of the present invention includes a display body, a light diffusing member that is provided at a viewing side of the display body and that outputs light in a state where angle distribution of the light entering from the display body is expanded relative to that before the light enters the light diffusing member, and an adhesive layer that is interposed between the display body and the light diffusing member. The light diffusing member includes a base having light transmissivity, a light diffuser formed with a predetermined height on a surface of the base facing the display body, and a light blocking layer formed in a region other than the light diffuser on the surface of the base facing the display body, the light blocking layer having a thickness smaller than the height of the light diffuser. The light diffuser has a light exit end surface that is in contact with the base, and a light entrance end surface that is opposite the light exit end surface and that has an area larger than an area of the light exit end surface. The light entrance end surface is adhered to the adhesive layer. The adhesive layer is formed of an adhesive that cures by being irradiated with activation energy.

(3) A display apparatus according to another aspect of the present invention includes a display body, a light diffusing member that is provided at a viewing side of the display body and that outputs light in a state where angle distribution of the light entering from the display body is expanded relative to that before the light enters the light diffusing member, and an adhesive sheet that is interposed between the display body and the light diffusing member. The adhesive sheet includes a base having light transmissivity and adhesive layers formed on opposite surfaces of the base. The light diffusing member includes a base having light transmissivity, a light diffuser formed with a predetermined height on a surface of the base facing the display body, and a light blocking layer formed in a region other than the light diffuser on the surface of the base facing the display body, the light blocking layer having a thickness smaller than the height of the light diffuser. The light diffuser has a light exit end surface that is in contact with the base, and a light entrance end surface that is opposite the light exit end surface and that has an area larger than an area of the light exit end surface. The light entrance end surface is adhered to one of the adhesive layers of the adhesive sheet.

(4) In the display apparatus according to any one of (1) to (3) described above, the light diffusing member may have a side surface formed between the light exit end surface and the light entrance end surface of the light diffuser and may have azimuthal anisotropy such that light diffusing power is relatively higher in a direction in which an area of the side surface is small than in a direction in which the area of the side surface is large.

(5) In the display apparatus according to (4) described above, the light diffusing member may have light diffusers with different azimuth directions of the azimuthal anisotropy.

(6) In the display apparatus according to any one of (1) to (5) described above, the light diffusing member may have a plurality of light diffusers randomly arranged as viewed in a direction of normal to a principal surface of the base, and the light blocking layer may be formed continuously in the region other than the light diffuser.

(7) In the display apparatus according to any one of (1) to (5) described above, the light diffusing member may have a plurality of light blocking layers randomly arranged as viewed in a direction of normal to a principal surface of the base, and the light diffuser may be formed continuously in a region other than the light blocking layers.

### Advantageous Effects of Invention

As described above, according to the aspects of the present invention, a display apparatus is provided, which suppresses deterioration of the light diffusing function of a light diffusing member when the light diffusing member is bonded to a display body via an adhesive layer.

### BRIEF DESCRIPTION OF DRAWINGS

FIG. 1 includes perspective views of a liquid crystal display apparatus according to an embodiment of the present invention.

FIG. 2 is a cross-sectional view illustrating a schematic configuration of the liquid crystal display apparatus.

FIG. 3 is a cross-sectional view illustrating a schematic configuration of a liquid crystal panel included in the liquid crystal display apparatus.

FIG. 4 illustrates a schematic configuration of a light diffusing member included in the liquid crystal display apparatus.

FIG. 5 includes diagrams for explaining an optical path of light transmitted through light diffusers in the light diffusing member.

FIG. 6 includes diagrams for explaining a viewing-angle expansion function of the light diffusing member.

FIG. 7 is a flowchart illustrating a manufacturing process for the light diffusing member.

FIG. 8 includes perspective views for explaining a sequential procedure of the manufacturing process for the light diffusing member.

FIG. 9 includes diagrams for explaining the arrangement of the light diffusers in the light diffusing member.

FIG. 10 includes diagrams for explaining a forming process for the light diffusers.

FIG. 11 is a perspective view illustrating an example of a manufacturing apparatus for the light diffusing member.

FIG. 12 includes perspective views illustrating a relevant part of the manufacturing apparatus.

FIG. 13 is a cross-sectional view illustrating a state where the light diffusing member is bonded to the liquid crystal panel via an adhesive layer, in accordance with a first embodiment.

FIG. 14 is a cross-sectional view illustrating an optical path of input light incident on a side surface of each light diffuser in a case where the thickness of the adhesive layer is larger than the height of a space.

FIG. 15 is a cross-sectional view illustrating an optical path of input light incident on the side surface of each light diffuser in a case where the thickness of the adhesive layer is smaller than the height of the space.

FIG. 16 is a cross-sectional view illustrating a state where the light diffusing member is bonded to the liquid crystal panel via the adhesive layer, in accordance with a second embodiment.

FIG. 17 is a cross-sectional view illustrating a state where the light diffusing member is bonded to the liquid crystal panel via an adhesive sheet, in accordance with a third embodiment.

FIG. 18 is a perspective view illustrating a light diffusing member according to a first configuration example.

FIG. 19 is a cross-sectional view of the light diffusing member.

FIG. 20 is a perspective view illustrating a light diffusing member according to a second configuration example.

FIG. 21 is a cross-sectional view of the light diffusing member.

FIG. 22 is a modification of the light diffusing member.

FIG. 23 is a plan view illustrating another configuration example of the light diffusing member.

FIG. 24 is a perspective view illustrating a light diffusing member according to a third configuration example.

FIG. 25 is a cross-sectional view of the light diffusing member.

FIG. 26 is a modification of the light diffusing member.

FIG. 27 is a plan view illustrating another configuration example of the light diffusing member.

### DESCRIPTION OF EMBODIMENTS

Embodiments of the present invention will be described in detail below with reference to the drawings.

In all of the following drawings, the dimensional scale shown may be varied depending on each component for better viewability of each component.

(Liquid Crystal Display Apparatus)

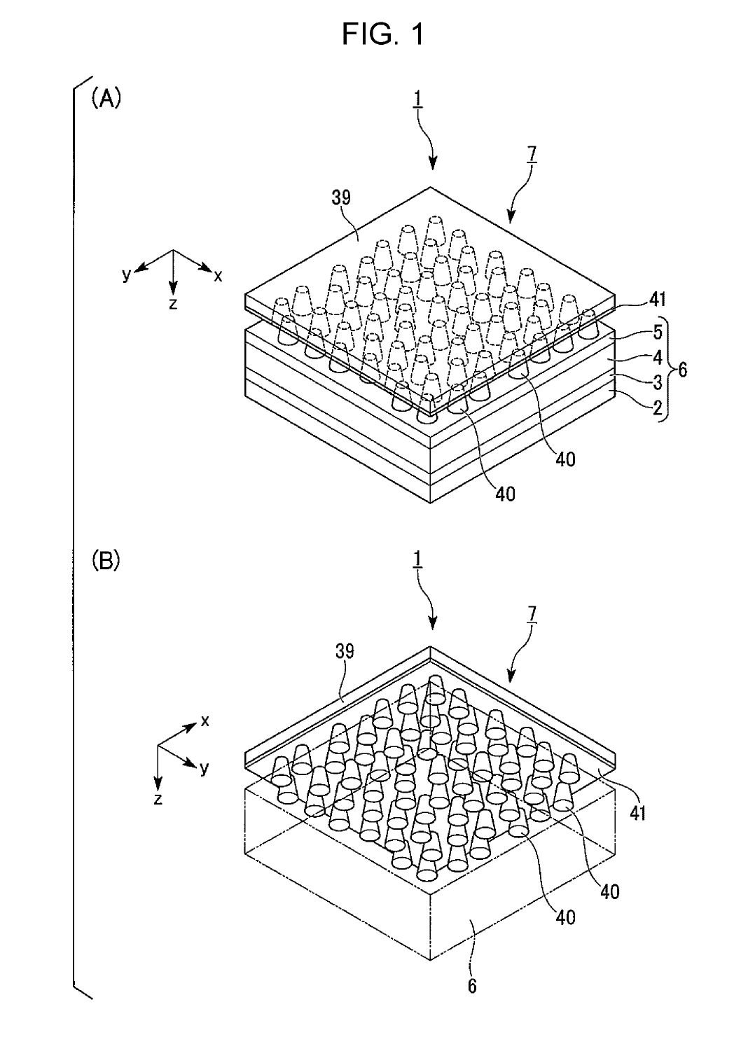

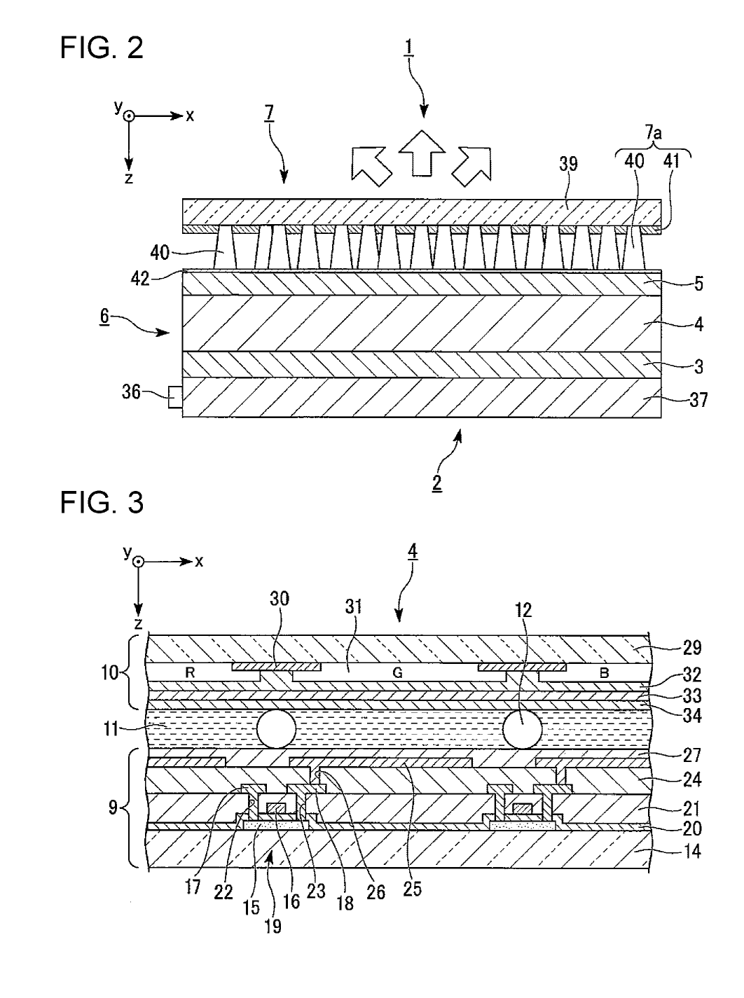

First, a liquid crystal display apparatus 1 shown in FIGS. 1(A), 1(B), and 2 will be described as an embodiment of the present invention. FIG. 1(A) is a perspective view of the liquid crystal display apparatus 1, as viewed from above. FIG. 1(B) is a perspective view of the liquid crystal display apparatus 1, as viewed from below. FIG. 2 is a cross-sectional view illustrating a schematic configuration of the liquid crystal display apparatus 1.

As shown in FIGS. 1(A), 1(B), and 2, the liquid crystal display apparatus 1 schematically includes a backlight 2, a first polarization plate 3, a liquid crystal panel 4, a second polarization plate 5, and a light diffusing member 7. Among these components, the backlight 2, the first polarization plate 3, the liquid crystal panel 4, and the second polarization plate 5 constitute a liquid crystal display body 6, which excludes the light diffusing member 7. In the following description, the side at which the light diffusing member 7 is disposed will be referred to as “viewing side”, whereas the side at which the backlight 2 is disposed will be referred to as “back side”.

The backlight 2 has a light source 36 formed of, for example, light emitting diodes or a cold-cathode tube and a light guide plate 37 that causes light emitted from the light source 36 to be output toward the liquid crystal panel 4 by utilizing internal reflection. The light source 36 is disposed at an end surface of the light guide plate 37 (which is called an edge lighting type). The light source 36 may alternatively be disposed directly below the light guide plate 37 (which is called a backlighting type).

In this embodiment, it is desirable that the backlight 2 used has directivity. By using such a backlight 2 having directivity, the light output direction is controlled so as to cause collimated light or substantially collimated light to enter the light diffusing member 7. Thus, blurriness is reduced, and the light utilization efficiency can be further enhanced. The backlight 2 can have directivity by optimizing, for example, the shape and arrangement of reflective patterns formed in the light guide plate 37.

The first polarization plate 3 functions as a polarizer and is disposed between the backlight 2 and the liquid crystal panel 4. The second polarization plate 5 functions as an analyzer and is disposed between the liquid crystal panel 4 and the light diffusing member 7.

The liquid crystal panel 4 is, for example, a transmissive liquid crystal panel. The liquid crystal panel 4 is not limited to a transmissive type and may be a semi-transmissive type (transmissive-reflective dual-purpose type) or reflective type liquid crystal panel. The liquid crystal panel 4 is an active-matrix liquid crystal panel and includes thin film transistors (TFTs) as switching elements that change the operation of pixels. The liquid crystal panel 4 is not limited to an active-matrix type and may be a simple-matrix liquid crystal panel not equipped with switching elements.

The light diffusing member 7 is a member (viewing-angle expansion film) that expands the viewing angle by diffusing the light exiting from the viewing side of the liquid crystal panel 4 and is provided at the viewing side of the liquid crystal panel 4 (i.e., on the second polarization plate 5).

In the liquid crystal display apparatus 1 having the above-described configuration, the light emitted from the backlight 2 is modulated by the liquid crystal panel 4, and a predetermined image or text, for example, is displayed with the modulated light. When the light exiting from the liquid crystal panel 4 is transmitted through the light diffusing member 7 and is to be output therefrom, the angle distribution of the output light becomes wider than that before the light enters the light diffusing member 7. Thus, an observer can view the display with a wide viewing angle.

(Liquid Display Panel)

Next, a specific configuration of the liquid crystal panel 4 will be described with reference to FIG. 3. FIG. 3 is a cross-sectional view illustrating a schematic configuration of the liquid crystal panel 4.

As shown in FIG. 3, the liquid crystal panel 4 schematically includes a TFT substrate (also called an element substrate) 9, a color filter substrate (also called an opposing substrate) 10 disposed facing the TFT substrate 9, and a liquid crystal layer 11 disposed between the TFT substrate 9 and the color filter substrate 10.

The liquid crystal layer 11 is sandwiched between the TFT substrate 9 and the color filter substrate 10 by sealing a surrounding region between the TFT substrate 9 and the color filter substrate 10 with a sealant (not shown) and injecting liquid crystal therebetween. Furthermore, spherical spacers 12 for maintaining a fixed distance between the TFT substrate 9 and the color filter substrate 10 are disposed therebetween.

The liquid crystal panel 4 according to this embodiment performs display in, for example, a VA (vertical alignment) mode and uses vertically-aligned liquid crystal molecules with negative dielectric anisotropy for the liquid crystal layer 11. The display mode used is not limited to the VA mode and may be, for example, a TN (twisted nematic) mode, an STN (super twisted nematic) mode, or an IPS (in-plane switching) mode.

The TFT substrate 9 has a plurality of pixels (not shown), which are the minimum unit regions of display, arranged in a matrix. The TFT substrate 9 has a plurality of source bus lines (not shown) formed to extend parallel to one another, and a plurality of gate bus lines (not shown) formed to extend parallel to one another and orthogonally to the plurality of source bus lines. Therefore, the plurality of source bus lines and the plurality of gate bus lines are formed in a grid pattern on the TFT substrate 9, and a rectangular region defined by a neighboring pair of source bus lines and a neighboring pair of gate bus lines serves as one pixel. The source bus lines are connected to source electrodes of the TFTs, to be described below, and the gate bus lines are connected to gate electrodes of the TFTs.

A liquid-crystal-layer-11-side surface of a transparent substrate 14 constituting the TFT substrate 9 is provided with TFTs 19 each having, for example, a semiconductor layer 15, a gate electrode 16, a source electrode 17, and a drain electrode 18. For example, a glass substrate may be used as the transparent substrate 14. The semiconductor layers 15 composed of a semiconductor material, such as CGS (continuous grain silicon), LPS (low-temperature polysilicon), or α-Si (amorphous silicon), are formed on the transparent substrate 14. Furthermore, a gate insulation film 20 is formed on the transparent substrate 14 so as to cover the semiconductor layers 15. As a material of the gate insulation film 20, for example, a silicon oxide film, a silicon nitride film, or a laminated film of these films is used. The gate electrodes 16 are formed on the gate insulation film 20 so as to face the semiconductor layers 15. As a material of the gate electrodes 16, for example, a W (tungsten)/TaN (tantalum nitride) laminated film, Mo (molybdenum), Ti (titanium), or Al (aluminum) is used.

A first interlayer dielectric film 21 is formed on the gate insulation film 20 so as to cover the gate electrodes 16. As a material of the first interlayer dielectric film 21, for example, a silicon oxide film, a silicon nitride film, or a laminated film of these films is used. The source electrodes 17 and the drain electrodes 18 are formed on the first interlayer dielectric film 21. The source electrodes 17 are connected to source regions of the semiconductor layers 15 via contact holes 22 extending through the first interlayer dielectric film 21 and the gate insulation film 20. Likewise, the drain electrodes 18 are connected to drain regions of the semiconductor layers 15 via contact holes 23 extending through the first interlayer dielectric film 21 and the gate insulation film 20. The source electrodes 17 and the drain electrodes 18 are composed of a conductive material similar to that of the aforementioned gate electrodes 16. A second interlayer dielectric film 24 is formed on the first interlayer dielectric film 21 so as to cover the source electrodes 17 and the drain electrodes 18. A material used for the second interlayer dielectric film 24 is a material similar to that of the aforementioned first interlayer dielectric film 21 or is an organic insulating material.

Pixel electrodes 25 are formed on the second interlayer dielectric film 24. The pixel electrodes 25 are connected to the drain electrodes 18 via contact holes 26 extending through the second interlayer dielectric film 24. Specifically, the pixel electrodes 25 are connected to the drain regions of the semiconductor layers 15 via the drain electrodes 18 as relay electrodes. As a material of the pixel electrodes 25, for example, a transparent conductive material, such as ITO (indium tin oxide) or IZO (indium zinc oxide), is used. With this configuration, when the TFTs 19 are turned on by being supplied with a scan signal via the gate bus lines, an image signal supplied to the source electrodes 17 via the source bus lines is supplied to the pixel electrodes 25 via the semiconductor layers 15 and the drain electrodes 18. Furthermore, an alignment film 27 is formed over the entire surface of the second interlayer dielectric film 24 so as to cover the pixel electrodes 25. The alignment film 27 has alignment control force for causing the liquid crystal molecules constituting the liquid crystal layer 11 to be vertically aligned. The TFTs may be top-gate TFTs shown in FIG. 3 or may be bottom-gate TFTs.

A liquid-crystal-layer-11-side surface of a transparent substrate 29 constituting the color filter substrate 10 is provided with a black matrix 30, color filters 31, a planarization layer 32, a counter electrode 33, and an alignment layer 34 in that order. The black matrix 30 has a function of blocking the transmission of light through regions between the pixels and is formed by using metal, such as a Cr (chromium) film or a chromium/chromium-oxide multilayer film, or a photoresist obtained by distributing carbon particles in photosensitive resin. The color filters 31 contain red (R), green (G), and blue (B) colorants, and any one of the R, G, and B color filters 31 is disposed facing one of the pixel electrodes 25 on the TFT substrate 9. The color filters 31 may alternatively have a multicolor configuration with three or more colors in addition to the R, G, and B colors. The planarization layer 32 is formed of an insulating film that covers the black matrix 30 and the color filters 31 and has a planarization function for alleviating steps formed by the black matrix 30 and the color filters 31. The counter electrode 33 is formed on the planarization layer 32. A material used for the counter electrode 33 is a transparent conductive material similar to that of the pixel electrodes 25. The alignment layer 34 having vertical alignment control force is formed over the entire surface of the counter electrode 33.

(Light Diffusing Member)

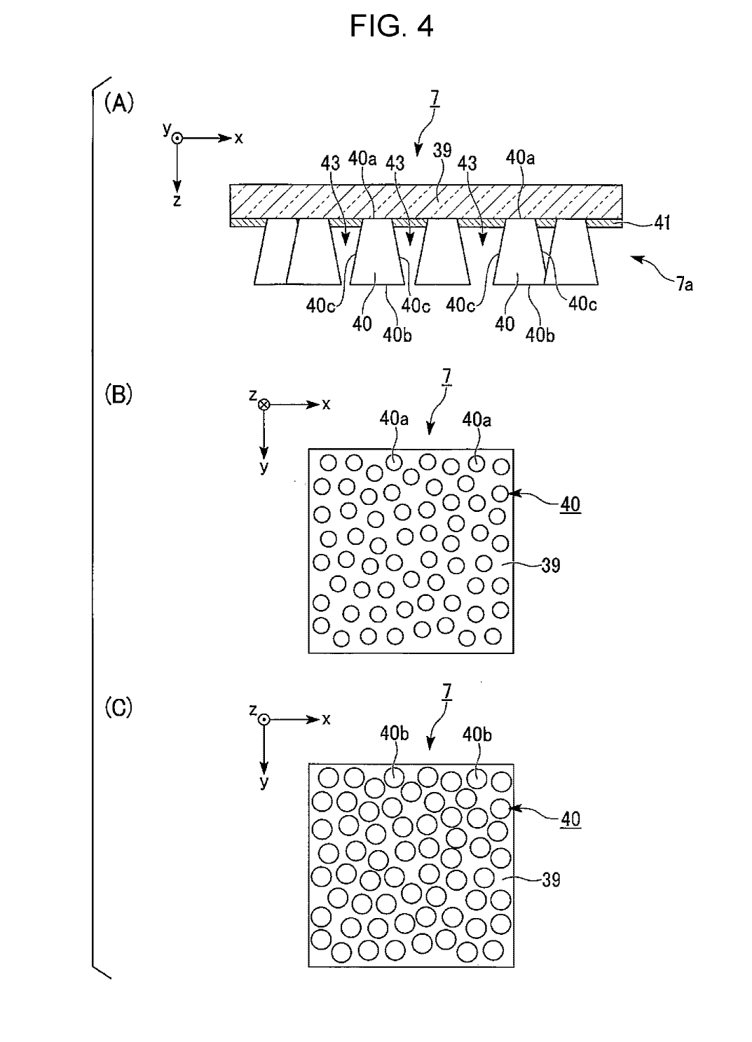

Next, a specific configuration of the light diffusing member 7 will be described with reference to FIGS. 4(A) to 4(C). FIG. 4(A) is a cross-sectional view illustrating a schematic configuration of the light diffusing member 7. FIG. 4(B) is a plan view of the light diffusing member 7, as viewed from the viewing side. FIG. 4(C) is a plan view of the light diffusing member 7, as viewed from the back side. An x axis shown in FIG. 4 indicates the horizontal direction of the screen of the liquid crystal panel 4, a y axis indicates the vertical direction of the screen of the liquid crystal panel 4, and a z axis indicates the thickness direction of the liquid crystal display apparatus 1.

As shown in FIGS. 4(A) to 4(C), the light diffusing member 7 schematically includes a base 39 having light transmissivity and a light control layer 7a formed on one surface (i.e., the surface opposite the viewing side) of the base 39. The light control layer 7a diffuses the light from the liquid crystal panel 4 and controls the light output direction, and is constituted of a plurality of light diffusers 40 formed on the one surface (i.e., the surface opposite the viewing side) of the base 39 and a light blocking layer (light absorber) 41.

The base 39 is preferably formed of a transparent resin film, such as a triacetyl cellulose (TAC) film, a polyethylene terephthalate (PET) film, a polycarbonate (PC) film, a polyethylene naphthalate (PEN) film, or a polyether sulfone (PES) film. The base 39 serves as a base layer when applying the materials of the light blocking layer 41 and the light diffusers 40 in subsequent steps of a manufacturing process to be described later, and needs to have heat resisting properties and mechanical strength in a heating step of the manufacturing process. Therefore, in place of a resinous base, a glass base, for example, may be used as the base 39. However, the thickness of the base 39 is preferably small to an extent such that the heat resisting properties and the mechanical strength are not impaired. This is because blurriness may possibly occur in the display as the thickness of the base 39 increases. In this embodiment, a transparent resin film with a thickness of 100 μm is used as an example of the base 39. Furthermore, the total light transmittance of the base 39 is preferably 90% or higher based on JIS K7361-1. By setting the total light transmittance to 90% or higher, sufficient transparency is obtained.

The plurality of light diffusers 40 are sections that contribute to transmission of light in the light diffusing member 7 and are randomly arranged as viewed from the direction of the normal to the principal surface of the base 39. The plurality of light diffusers 40 are composed of, for example, an organic material having light transmissivity and photosensitivity, such as acrylic resin or epoxy resin. The total light transmittance of the light diffusers 40 is preferably 90% or higher based on JIS K7361-1. By setting the total light transmittance to 90% or higher, sufficient transparency is obtained.

Each light diffuser 40 has a circular shape in cross section taken along a horizontal plane (x-y plane), and a surface (referred to as “light exit end surface”) 40a thereof at the base-39 side has a small area whereas a surface (referred to as “light entrance end surface”) 40b thereof opposite the base 39 has a large area, such that the horizontal cross-sectional area gradually increases from the base-39 side toward the side opposite the base 39. Therefore, each light diffuser 40 has a circular truncated cone shape with a side surface 40c that is inversely tapered from the base-39 side toward the side opposite the base 39.

The slope angle (i.e., the angle formed by the light entrance end surface 40b and the side surface 40c) of the side surface 40c of each light diffuser 40 is, for example, about 80°. However, the slope angle of the side surface 40c of each light diffuser 40 is not particularly limited so long as the angle allows the input light to be sufficiently diffused when the light exits the light diffusing member 7.

The light blocking layer 41 blocks (absorbs) light leaking from the side surfaces 40c of the light diffusers 40 and is formed continuously in a region other than the regions where the light diffusers 40 are formed on the surface of the base 39 provided with the light diffusers 40. The light blocking layer 41 is composed of, for example, an organic material having light absorbency and photosensitivity, such as a black resist. Alternatively, for example, a metallic film, such as a Cr (chromium) film, or a chromium/chromium-oxide multilayer film may be used as the light blocking layer 41.

The layer thickness of the light blocking layer 41 is set to be smaller than the height from the light entrance end surface 40b to the light exit end surface 40a of each light diffuser 40. In the case of this embodiment, the layer thickness of the light blocking layer 41 is, for example, about 150 nm, and the height from the light entrance end surface 40b to the light exit end surface 40a of each light diffuser 40 is, for example, about 25 μm. Therefore, a space 43 is formed between the light diffusers 40 and the light blocking layer 41, and an air layer exists in this space 43.

It is desirable that the refractive index of the base 39 and the refractive index of each light diffuser 40 be substantially equal to each other. This is because, for example, if the refractive index of the base 39 and the refractive index of each light diffuser 40 largely differ from each other, undesired light refraction or reflection occurs at the interface between the light diffuser 40 and the base 39 when the light entering from the light entrance end surface 40b is to exit from the light diffuser 40, possibly causing problems, such as an inability to obtain a desired viewing angle or a reduced quantity of output light.

The light diffusing member 7 having the above-described configuration is disposed at the viewing side of the liquid crystal display body 6, as shown in FIG. 2.

Specifically, the light diffusers 40 are bonded to the second polarization plate 5 via an adhesive layer 42 in a state where the other surface of the base 39 faces the viewing side.

In the liquid crystal display apparatus 1, the light diffusing member 7 is disposed at the viewing side of the liquid crystal display body 6 so that the viewing angle can be expanded while diffusing the light exiting from the viewing side of the liquid crystal panel 4.

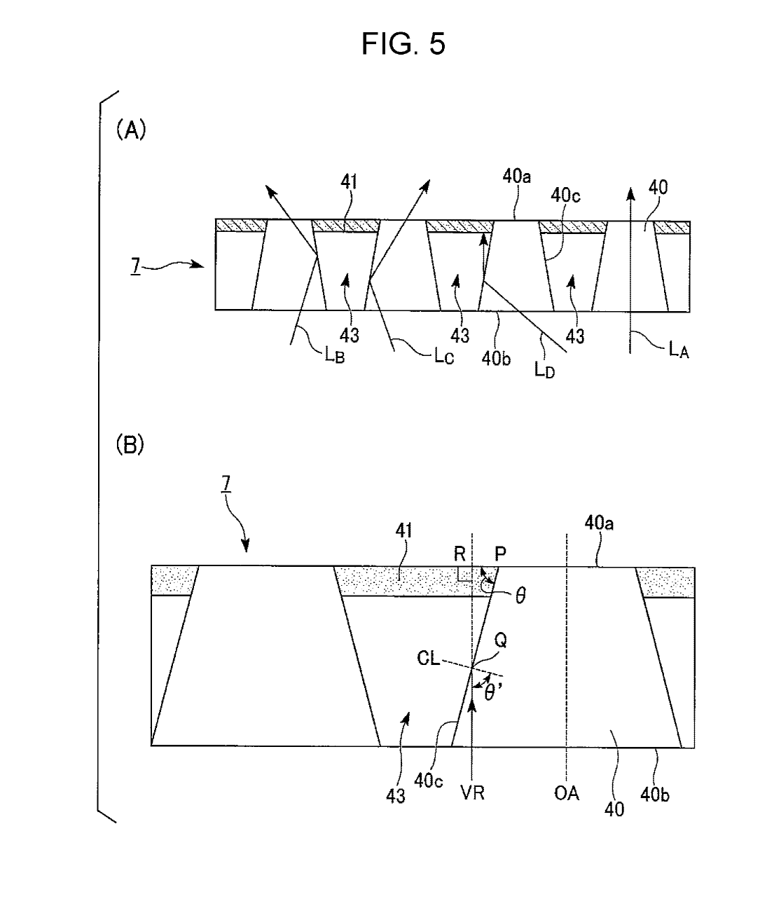

An optical path of light transmitted through the light diffusers 40 in the light diffusing member 7 will now be described with reference to FIG. 5(A).

Among light beams LA, LB, LC, and LD entering each light diffuser 40 from the light entrance end surface 40b thereof, the light beams LB and LC incident on the side surface 40c at angles that exceed the critical angle are transmitted through the light diffuser 40 while undergoing total reflection at the side surface 40c and exit the light diffuser 40 from the light exit end surface 40a. The input light beam LA not incident on the side surface 40c is directly transmitted through the light diffuser 40 and exits the light diffuser 40 from the light exit end surface 40a.

The input light beam LD incident on the side surface 40c at an angle smaller than or equal to the critical angle exits the light diffuser 40 from the side surface 40c without undergoing total reflection at the side surface 40c and is subsequently absorbed by the light blocking layer 41. Thus, blurriness in the display as well as reduced contrast can be prevented.

However, when the light transmitted through the side surface 40c increases, loss in light quantity occurs, making it impossible to obtain an image with high brightness. In the liquid crystal display apparatus 1, the aforementioned backlight 2 having directivity is used so as to allow light to be incident on the side surface 40c at an angle that exceeds the critical angle.

Specifically, the slope angle of each side surface 40c for allowing light to be incident on the side surface 40c at an angle that exceeds the critical angle will be described with reference to FIG. 5(B).

The angle formed by the side surface 40c and the light exit end surface 40a of each light diffuser 40 is set to an angle θ′ [°] that exceeds the critical angle relative to the normal CL to the side surface 40c of the light diffuser 40 so as to cause light entering parallel to or substantially parallel to an optical axis OA to undergo total reflection.

Furthermore, an angle θ formed by the side surface 40c of the light diffuser 40 and the light exit end surface 40a orthogonal to the optical axis OA can be expressed by an angle QPR, assuming that the point where the side surface 40c of the light diffuser 40 intersects the light exit end surface 40a is defined as point P, an incident point where input light VR parallel to the optical axis OA is incident on the side surface 40c is defined as point Q, and an intersection point between the light exit end surface 40a and a line perpendicular to the light exit end surface 40a and passing through point Q is defined as point R.

In this case, since the value of an angle PQR is (90−θ)°, the slope angle θ of the side surface 40c of the light diffuser 40 is the same as the incident angle θ′ of the input light VR at point Q. Therefore, the slope angle θ of the side surface 40c of the light diffuser 40 is an angle that exceeds the aforementioned critical angle.

Because the light diffusing member 7 has the air layer (i.e., the space 43) between neighboring light diffusers 40, if the light diffusers 40 are composed of, for example, transparent acrylic resin, the side surface 40c of each light diffuser 40 serves as an interface between the transparent acrylic resin and the air layer. Assuming that the surrounding region of the light diffuser 40 is filled with another material having a low refractive index, the refractive-index difference at the interface between the inside and the outside of the light diffuser 40 becomes maximum when there is the air layer outside, as compared with when there is any kind of low-refractive-index material outside. Therefore, in this light diffusing member 7, the critical angle is minimized due to Snell's law, and the incident-angle range in which light undergoes total reflection at the side surface 40c of each light diffuser 40 is maximized As a result, loss of light is further suppressed, and high brightness can be obtained.

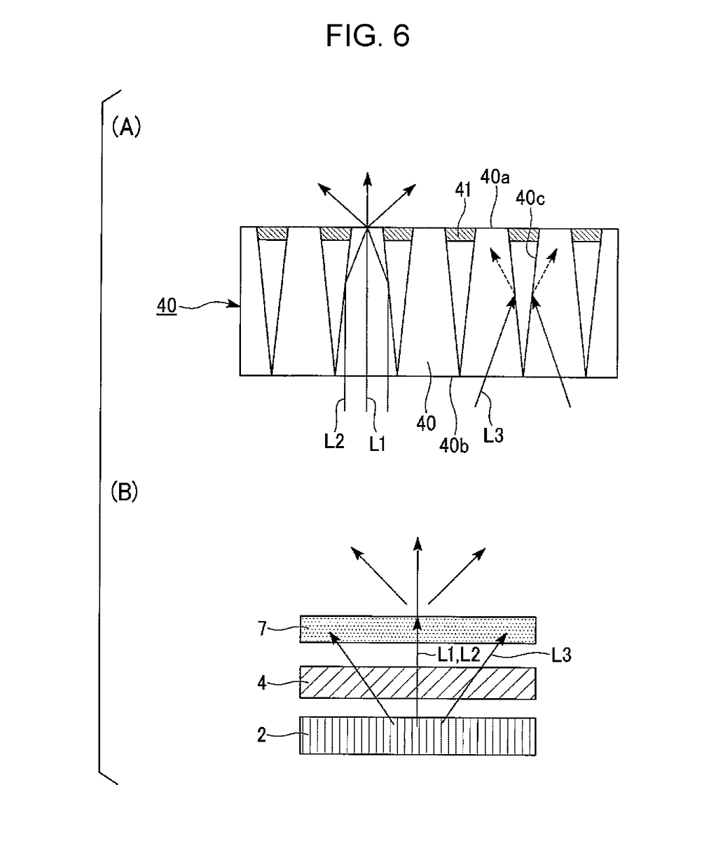

A viewing-angle expansion function of the light diffusing member 7 will now be described with reference to FIGS. 6(A) and 6(B).

As shown in FIG. 6(A), of the light beams entering each light diffuser 40 from the light entrance end surface 40b, a light beam L1 entering near the center of the light diffuser 40 at an angle substantially orthogonal to the light entrance end surface 40b travels straight through the light diffuser 40 and is transmitted therethrough without undergoing total reflection at the side surface 40c of the light diffuser 40.

A light beam L2 entering a peripheral region of the light diffuser 40 at an angle substantially orthogonal to the light entrance end surface 40b becomes incident on the side surface 40c of the light diffuser at an incident angle larger than the critical angle so as to undergo total reflection at the side surface 40c of the light diffuser 40. The totally reflected light is refracted at the light exit end surface 40a of the light diffuser 40 and is output in a direction that forms a large angle relative to the direction of the normal to the light exit end surface 40a.

A light beam L3 entering the light diffuser 40 diagonally relative to the light entrance end surface 40b becomes incident on the side surface 40c of the light diffuser 40 at an incident angle smaller than the critical angle so as to be transmitted through the side surface 40c of the light diffuser 40 and be absorbed by the light blocking layer 41.

Due to the above-described function, the light beams L1 and L2 entering substantially orthogonally to the light diffusing member 7 are output from the light diffusing member 7 in a state where the angle distribution is expanded relative to that before the light beams enter the light diffusing member 7, as shown in FIG. 6(B). Therefore, the observer can view a good display even when the observer tilts his/her line of vision from the forward direction of (i.e., the direction of the normal to) the liquid crystal display apparatus 1.

In particular, in the case of this embodiment, because the planar shape of each light diffuser 40 is circular, the angle distribution is expanded in all directions centered on the direction of the normal to the screen of the liquid crystal display apparatus 1. Therefore, the observer can view a good display in all directions. In other words, by using this light diffusing member 7, the viewing angle of the liquid crystal display apparatus 1 can be expanded.

The light beam L3 diagonally entering the light diffusing member 7 is a light beam transmitted diagonally through the liquid crystal panel 4 and is a light beam different from desired retardation. In other words, the light beam L3 causes the contrast of the display to deteriorate. The light diffusing member 7 uses the light blocking layer 41 to block such a light beam so as to enhance the contrast of the display.

Normally, in a case where patterns with regularities, such as stripes and grids, are laid one on top of the other, if the periodicity of each pattern is slightly deviated, it is known that moiré fringes are visually observed. For example, assuming that a light diffusing member having a plurality of light diffusers arranged in a matrix and a liquid crystal panel having a plurality of pixels arranged in a matrix are laid one on top of the other, moiré fringes occur between the periodical pattern formed by the light diffusers of the light diffusing member and the periodical pattern formed by the pixels of the liquid crystal panel, possibly lowering the quality level of display.

In contrast, in the liquid crystal display apparatus 1 using the light diffusing member 7 according to this embodiment, since the plurality of light diffusers 40 are randomly arranged in the planar direction, the quality level of display can be maintained without causing moiré fringes to occur due to interference with the regular array of pixels of the liquid crystal panel 4.

(Method of Manufacturing Light Diffusing Member)

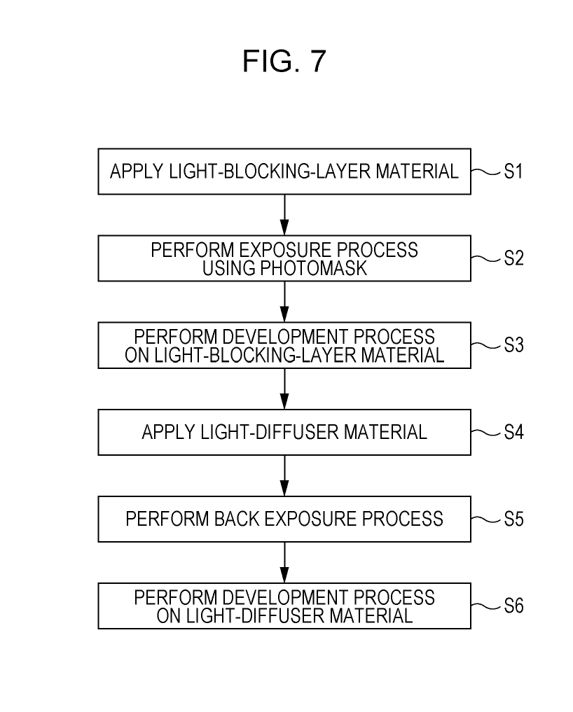

Next, a method of manufacturing the light diffusing member 7 will be described with reference to FIGS. 7 to 9.

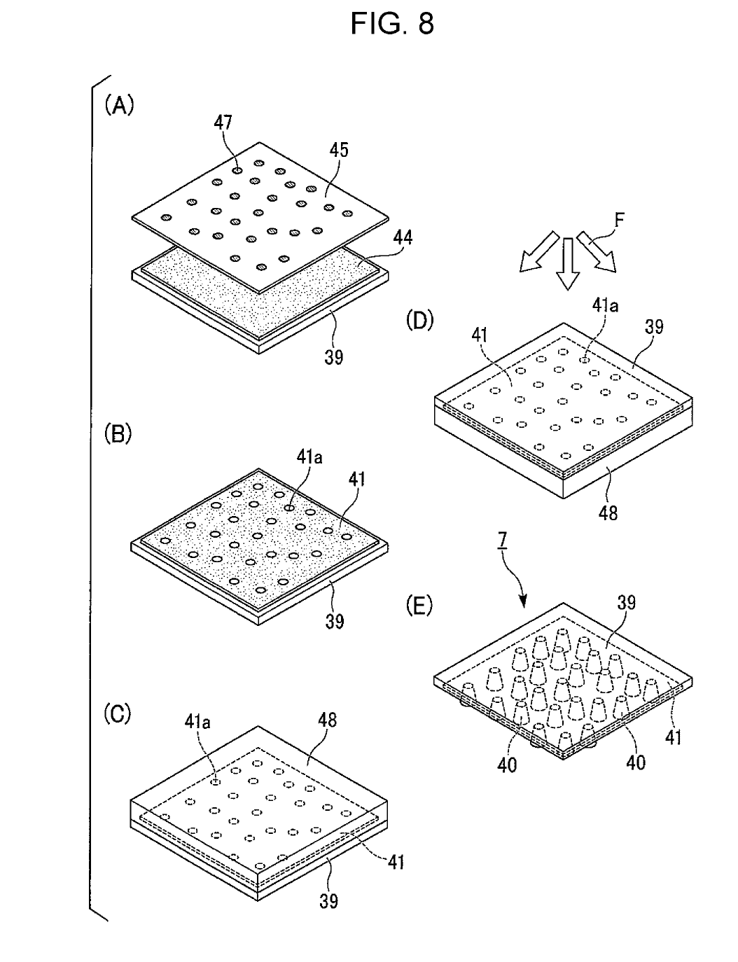

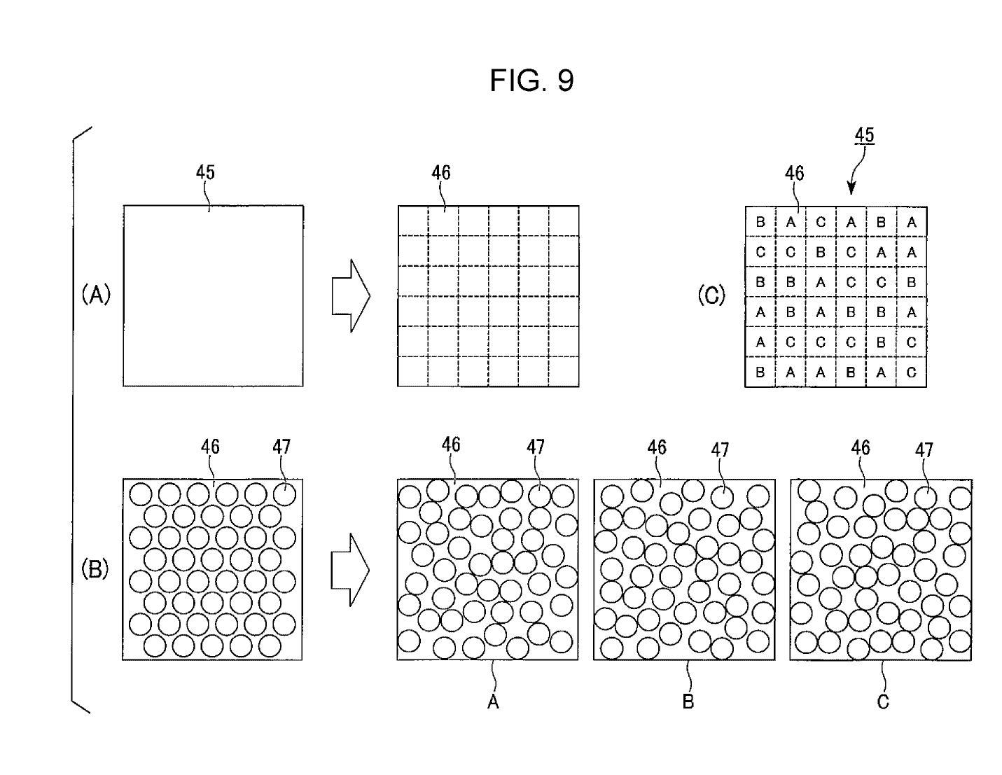

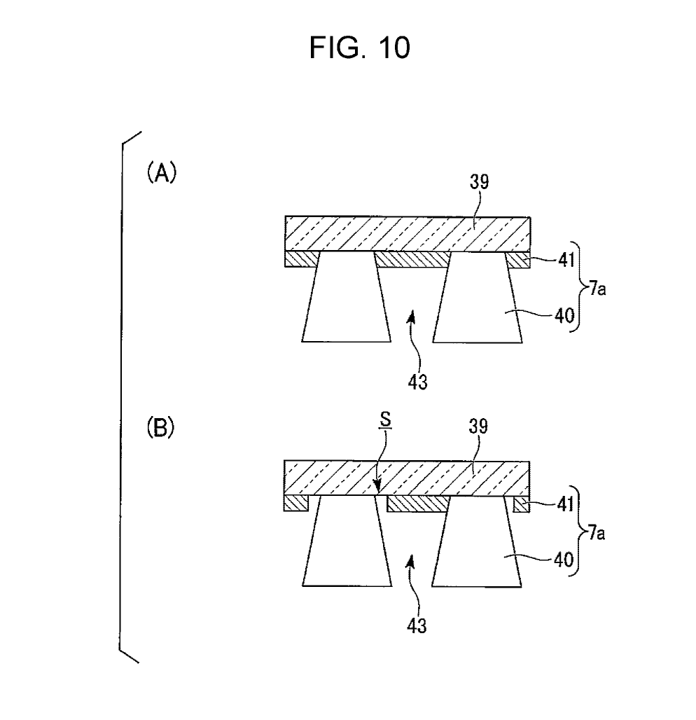

FIG. 7 is a flowchart illustrating a manufacturing process for the light diffusing member 7. FIG. 8 includes perspective views for explaining a sequential procedure of the manufacturing process for the light diffusing member 7. FIG. 9 includes diagrams for explaining the arrangement of the light diffusers 40 in the light diffusing member 7. FIG. 10 includes diagrams for explaining a forming process for the light diffusers 40.

When manufacturing the light diffusing member 7, one surface of the base 39 is first coated with a light-blocking-layer material in step S1 shown in FIG. 7. Specifically, as shown in FIG. 8(A), for example, a 10-cm-square base 39 composed of triacetyl cellulose and having a thickness of 100 μm is prepared. Then, a black negative resist containing carbon is applied as a light-blocking-layer material onto the one surface of this base 39 by spin coating, thereby forming a coating film 44 having a layer thickness of 150 nm. Subsequently, the base 39 having the coating film 44 formed thereon is placed on a hot plate, and the coating film 44 is pre-baked at a temperature of 90° C. Thus, the solvent in the black negative resist volatilizes.

Then, in step S2 shown in FIG. 7, an exposure process using a photomask is performed on the coating film 44. Specifically, as shown in FIG. 8(A), the coating film 44 is exposed to light by using a photomask 45 having a plurality of light blocking patterns 47 randomly arranged therein.

In this case, the exposure process is performed by using a mixture ray including an i-ray with a wavelength of 365 nm, an h-ray with a wavelength of 404 nm, and a g-ray with a wavelength of 436 nm. The light exposure is set to 100 mJ/cm². In this embodiment, since the light diffusers 40 are to be formed in a subsequent step by performing an exposure process on a transparent negative resist by using the light blocking layer 41 as a mask, the positions of the light blocking patterns 47 in the photomask 45 correspond with positions where the light diffusers 40 are to be formed.

The plurality of light blocking patterns 47 are all circular patterns with a diameter of 20 μm and are randomly arranged. Therefore, although the distance (i.e., the pitch) between neighboring light blocking patterns 47 is not fixed, an average distance obtaining by averaging out the distances between the plurality of light blocking patterns 47 is 25 μm.

Furthermore, the average distance between the light blocking patterns 47 is desirably smaller than the distance (i.e., the pitch) between the pixels of the liquid crystal panel 4. Thus, at least one light diffuser 40 is formed within each pixel, so that a wide viewing angle can be achieved when the light diffusing member 7 is combined with a liquid crystal panel having a small pixel pitch used in, for example, a mobile device.

An example of a technique for designing the photomask 45 having the plurality of light blocking patterns 47 randomly arranged therein will now be described with reference to FIGS. 9(A) to 9(C).

With regard to the designing of the photomask 45, the entire photomask 45 is first segmented into m×n (e.g., 36) regions 46 constituted of m (e.g., six) vertical regions and n (e.g., six) horizontal regions, as shown in FIG. 9(A).

Then, as shown at the left side in FIG. 9(B), in each of the segmented regions 46, a pattern is fabricated such that circles corresponding to the shape of the light blocking patterns 47 are arranged in a closest-packed manner.

Subsequently, as shown in the three sections at the right side in FIG. 9(B), positional data based on the positions of the circles, such as the central coordinates of the circles, is given fluctuations by using a random function, thereby fabricating multiple types (e.g., three types of patterns A, B, and C) of positional data.

Then, as shown in FIG. 9(C), the multiple fabricated types of positional data A, B, and C are randomly allocated to the m×n regions. For example, the positional data A, B, and C are allocated to the regions 46 so that the positional data A, the positional data B, and the positional data C randomly appear in the 36 regions 46.

Consequently, when each region 46 of the photomask 45 is observed, the arrangement of the light blocking patterns 47 in the region 46 corresponds to any one of the positional data A, the positional data B, and the positional data C. Therefore, although not all light blocking patterns 47 are completely randomly arranged in all regions, the plurality of light blocking patterns 47 are randomly arranged when the entire photomask 45 is observed.

Subsequently, in step S3 shown in FIG. 7, a development process is performed on the coating film 44 that has undergone the exposure process. Specifically, as shown in FIG. 8(B), after performing the development process on the coating film 44 formed of the black negative resist by using a dedicated developer, the coating film 44 is dried at 100° C. Thus, a light blocking layer 41 having a plurality of circular openings 41a is formed on the one surface of the base 39.

The openings 41a correspond with regions where the light diffusers 40 are to be formed in a subsequent step. Although the light blocking layer 41 is formed by photolithography using a black negative resist in this embodiment, a positive resist may alternatively be used in place of this configuration by using a photomask in which the light blocking patterns 47 according to this embodiment and light transmitters are inverted. As another alternative, the light blocking layer 41 may be formed by using, for example, a vapor deposition technique or a printing technique.

Subsequently, in step S4 shown in FIG. 7, a light-diffuser material is applied onto the one surface of the base 39. Specifically, as shown in FIG. 8(C), a transparent negative resist composed of acrylic resin is applied as the light-diffuser material onto the upper surface of the light blocking layer 41 by using spin coating so as to form a coating film 48 having a layer thickness of 25 μm. Then, the base 39 having the coating film 48 formed thereon is placed on a hot plate, and the coating film 48 is pre-baked at a temperature of 95° C. Thus, the solvent in the transparent negative resist volatilizes.

Subsequently, in step S5 shown in FIG. 7, a back exposure process is performed on the coating film 48. Specifically, as shown in FIG. 8(D), the base 39 is turned over, and an exposure process is performed by radiating diffusion light F onto the coating film 48 from the base-39 side by using the light blocking layer 41 as a mask.

In this case, the exposure process is performed by using a mixture ray including an i-ray with a wavelength of 365 nm, an h-ray with a wavelength of 404 nm, and a g-ray with a wavelength of 436 nm. The light exposure is set to 500 mJ/cm². Furthermore, the diffusion light F can be obtained by, for example, disposing a diffuser plate with a haze of about 50 in an optical path of collimated light emitted from an exposure device. Subsequently, the base 39 having the coating film 48 formed thereon is placed on a hot plate, and the coating film 48 undergoes post exposure baking (PEB) at a temperature of 95° C.

Then, in step S6 shown in FIG. 7, a development process is performed on the coating film 48 that has undergone the exposure process. Specifically, as shown in FIG. 8(E), after performing the development process on the coating film 48 formed of the transparent negative resist by using a dedicated developer, the coating film 48 is post-baked at 100° C. Thus, a plurality of light diffusers 40 are formed on the one surface of the base 39.

As a result of the above-described steps, a light diffusing member 7 can be obtained. The total light transmittance of the light diffusing member 7 is preferably 90% or higher. By setting the total light transmittance to 90% or higher, sufficient transparency is obtained, and the light diffusing function required in the light diffusing member can be sufficiently exhibited. The total light transmittance is based on JIS K7361-1.

In the process for forming the above-described light diffusers 40 in this embodiment, light is radiated from the back side of the base 39 by using the light blocking layer 41 as a mask. Thus, the light diffusers 40 are formed in a state where they are self-aligned at the positions of the openings 41a in the light blocking layer 41. As a result, as shown in FIG. 10(A), the light diffusers 40 and the light blocking layer 41 are closely attached to each other and have no gap therebetween, whereby the contrast can be reliably maintained.

In contrast, assuming that light is radiated via a photomask from the side of the coating film 48 formed of the transparent negative resist in the process for forming the above-described light diffusers 40, it is extremely difficult to perform alignment adjustment between the base 39 having the small-size light blocking layer 41 formed thereon and the photomask, making it impossible to avoid the occurrence of deviation. As a result, as shown in FIG. 10(B), gaps S are formed between the light diffusers 40 and the light blocking layer 41, possibly deteriorating the contrast due to leakage of light from the gaps S.

Furthermore, in a case where the base 39 is not provided with the light blocking layer 41, external light entering the light diffusing member 7 may also scatter. When scattering of external light occurs, not only does the viewability deteriorate in bright areas, but a misadjusted-black-level phenomenon in which the black color in black display appears to be whitish also occurs and deteriorates the contrast, thus making it impossible to perform proper image observation. In order to prevent these problems, the light blocking layer 41 is disposed on the base 39.

Although the exposure process is performed on the coating film 48 in a state where the base 39 is turned over in this embodiment, the exposure process may alternatively be performed from the base-39 side without turning over the base 39, depending on the manufacturing apparatus.

Furthermore, as an alternative to this embodiment in which a liquid resist is applied when forming the light blocking layer 41 and the light diffusers 40, a film resist may be bonded to the one surface of the base 39.

As shown in FIG. 2, the fabricated light diffusing member 7 is bonded to the liquid crystal display body 6. Specifically, in a state where the base 39 is oriented toward the viewing side and the light diffusers 40 face the second polarization plate 5, the light diffusing member 7 is bonded to the second polarization plate 5 via the adhesive layer 42 formed on the surface of the second polarization plate 5.

As a result of the above-described steps, a liquid crystal display apparatus 1 can be fabricated.

With regard to a manufacturing process for the liquid crystal display body 6, the TFT substrate 9 and the color filter substrate 10 are first fabricated. Then, the TFT substrate 9 and the color filter substrate 10 are disposed such that the surface of the TFT substrate 9 provided with the TFTs 19 and the surface of the color filter substrate 10 provided with the color filters 31 face each other. The TFT substrate 9 and the color filter substrate 10 are then bonded to each other via a sealant. Subsequently, liquid crystal is injected into a space surrounded by the TFT substrate 9, the color filter substrate 10, and the sealant. By using, for example, an optical adhesive, the first polarization plate 3 and the second polarization plate 5 are respectively bonded to the opposite surfaces of the liquid crystal panel 4 formed in this manner. As a result of the above-described steps, a liquid crystal display body 6 is fabricated.

With regard to methods for manufacturing the TFT substrate 9 and the color filter substrate 10, since known methods in the related art are used, descriptions thereof will be omitted.

(Manufacturing Apparatus for Light Diffusing Member)

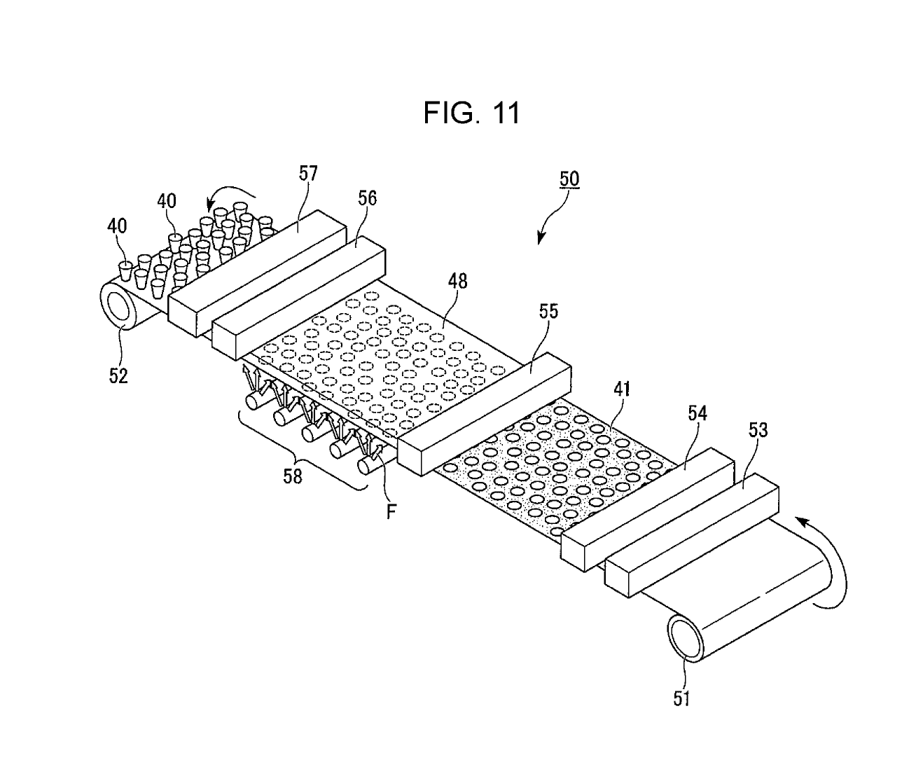

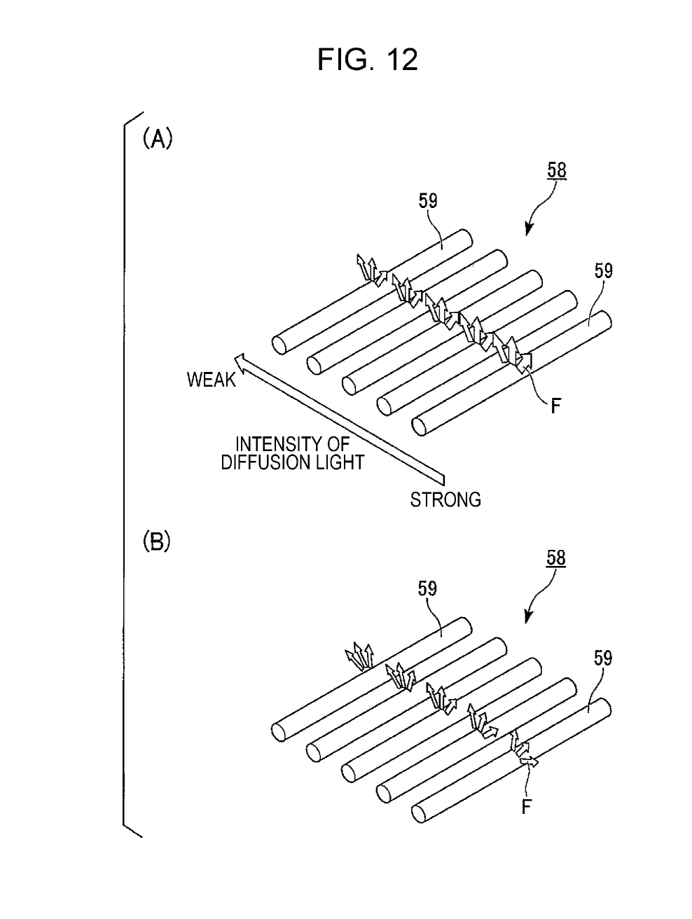

Next, an example of a manufacturing apparatus 50 for the light diffusing member 7 shown in FIGS. 11 and 12 will be described.

FIG. 11 is a perspective view illustrating the configuration of the manufacturing apparatus 50. FIG. 12 includes perspective views illustrating a relevant part of the manufacturing apparatus 50.

As shown in FIG. 11, the manufacturing apparatus 50 conveys a long base 39 in a roll-to-roll fashion and performs various kinds of processes in-between. Moreover, for forming a light blocking layer 41, the manufacturing apparatus 50 uses a printing technique in place of the photolithography technique using the aforementioned photomask 45.

The manufacturing apparatus 50 has one end provided with a feed roller 51 that feeds the base 39 and the other end provided with a winding roller 52 that winds up the base 39, so as to move the base 39 from the feed-roller-51 side toward the winding-roller-52 side.

A printing device 53, a first drying device 54, a coating device 55, a developing device 56, and a second drying device 57 are arranged above the base 39 in this order from the feed-roller-51 side toward the winding-roller-52 side.

The printing device 53 is for printing the light blocking layer 41 onto the base 39. The first drying device 54 is for drying the light blocking layer 41 formed by printing. The coating device 55 is for applying a transparent negative resist onto the light blocking layer 41. The developing device 56 is for developing the transparent negative resist after an exposure process by using a developer. The second drying device 57 is for drying the base 39 having formed therein light diffusers 40 formed of the developed transparent resist. Subsequently, the base 39 having the light diffusers 40 formed therein may be bonded to a second polarization plate 5 so as to integrate the light diffusing member 7 with the polarization plate.

An exposure device 58 is disposed below the base 39. The exposure device 58 is for performing an exposure process on a coating film 48 formed of the transparent negative resist from the base-39 side. FIGS. 12(A) and 12(B) are partial views of the manufacturing apparatus 50, illustrating only the exposure device 58 thereof.

As shown in FIG. 12(A), the exposure device 58 includes a plurality of light sources 59. In the exposure device 58, the intensity of diffusion light F may be varied such that, for example, the intensities of diffusion light F from the light sources 59 gradually decrease as the base 39 proceeds. Moreover, as shown in FIG. 12(B), in the exposure device 58, the emission angles of diffusion light F from the light sources 59 may gradually change as the base 39 proceeds. By using such an exposure device 58, the slope angles of the side surfaces 40c of the light diffusers 40 can be controlled to desired angles.

### First Embodiment

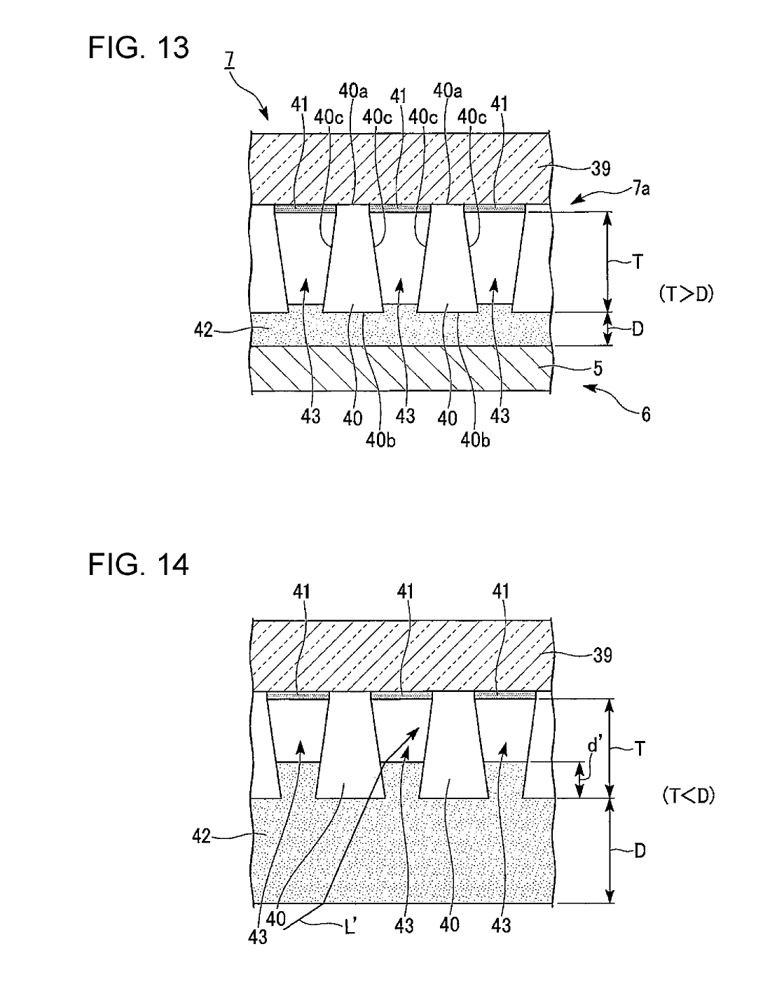

As shown in FIG. 13, in the liquid crystal display apparatus 1 according to a first embodiment of the present invention, a thickness D of the adhesive layer 42 is smaller than a height T from the light blocking layer 41 to the light entrance end surface 40b in the space 43 formed between each light diffuser 40 and the light blocking layer 41 (T>D). Thus, when the light diffusing member 7 is bonded to the liquid crystal display body 6, deterioration of the light diffusing function of the light diffusing member 7 is suppressed.

Specifically, in this light diffusing member 7, in order to cause input light to undergo total reflection at the side surface 40c of each light diffuser 40, it is desirable that the refractive-index difference at the interface between the inner side and the outer side of the side surface 40c of the light diffuser 40 be large.

In the light diffusing member 7, an air layer exists in the space 43 formed between each light diffuser 40 and the light blocking layer 41. Thus, the refractive-index difference can be maximized between the light diffuser 40, which is the high-refractive-index side, and the air layer, which is the low-refractive-index side, with the side surface 40c interposed therebetween.

In a case where the adhesive layer 42 intrudes into the space 43, the refractive-index difference between the side surface 40c of each light diffuser 40 and the adhesive layer 42 decreases. In this case, the light diffusing function of the light diffusing member 7 deteriorates, as compared with that before the bonding process.

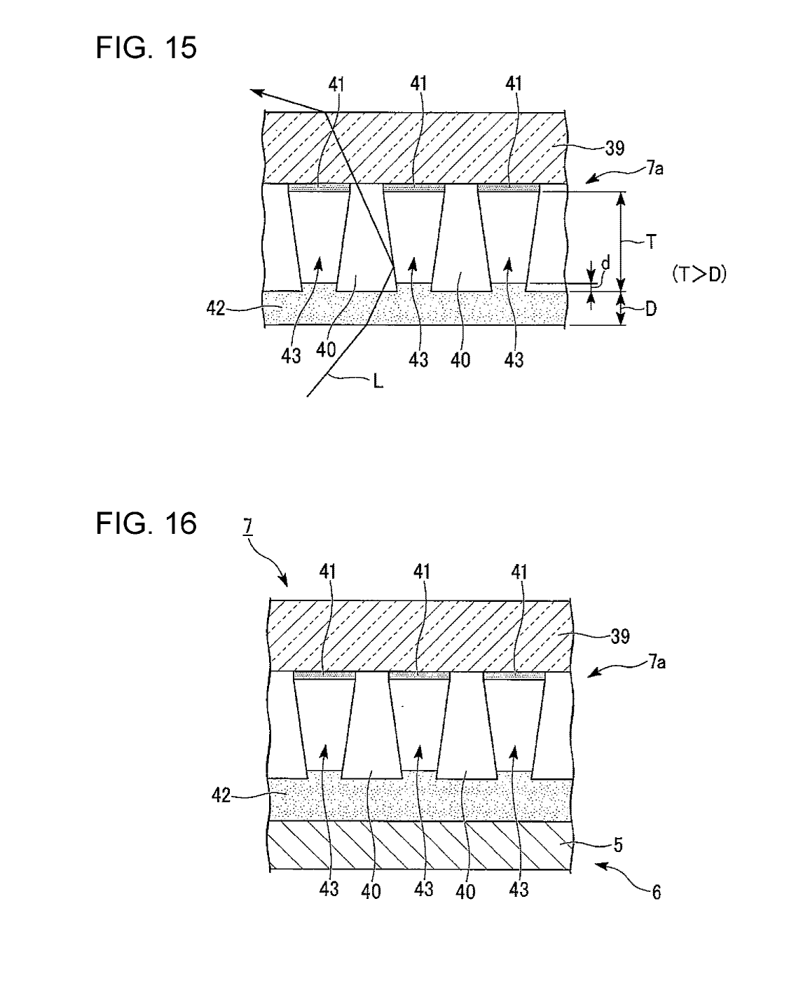

FIG. 14 illustrates an optical path of input light L′ incident on the side surface 40c of each light diffuser 40 in a case where the thickness D of the adhesive layer 42 is larger than the height T of the space 43 (T<D). In contrast, FIG. 15 illustrates an optical path of input light L incident on the side surface 40c of each light diffuser 40 in a case where the thickness D of the adhesive layer 42 is smaller than the height T of the space 43 (T>D), as in this embodiment.

As shown in FIGS. 14 and 15, if the elastic coefficient of the adhesive layer 42 is the same, the amount of adhesive layer 42 intruding into the space 43 through between the light diffusers 40 when the light diffusing member 7 is pressure-bonded to the liquid crystal display body 6 can be reduced as the thickness D of the adhesive layer 42 decreases. Moreover, in the case where the thickness D of the adhesive layer 42 is smaller than the height T of the space 43, the space 43 will not be completely filled with the adhesive layer 42.

Therefore, a thickness d′ of the adhesive layer 42 intruding into the space 43 in the case where the thickness D of the adhesive layer 42 is larger than the height T of the space 43 (T<D), as shown in FIG. 14, is larger than a thickness d of the adhesive layer 42 intruding into the space 43 in the case where the thickness D of the adhesive layer 42 is smaller than the height T of the space 43 (T>D), shown in FIG. 15 (d′>d).

Thus, in the case where the thickness D of the adhesive layer 42 is larger than the height T of the space 43 (T<D), as shown in FIG. 14, the input light L′ incident on the side surface 40c of each light diffuser 40 becomes transmitted through the side surface 40c and absorbed by the light blocking layer 41 without undergoing total reflection at the intruding portion of the adhesive layer 42. In this case, since it is not possible to extract the input light L from the light exit end surface 40a, the brightness of display decreases by that amount.

In contrast, in the case where the thickness D of the adhesive layer 42 is smaller than the height T of the space 43 (T>D), as shown in FIG. 15, the input light L incident on the side surface 40c of each light diffuser 40 can undergo total reflection at the interface with the air layer (i.e., the space 43). In this case, the light utilization efficiency can be enhanced, and good viewing-angle characteristics can be obtained.

Based on such expertise, the thickness D of the adhesive layer 42 is set to be smaller than the height T of the space 43 in the liquid crystal display apparatus 1 according to this embodiment. Consequently, when the light diffusing member 7 is bonded to the liquid crystal display body 6, deterioration of the light diffusing function of the light diffusing member 7 can be suppressed while suppressing intrusion of the adhesive layer 42 into the space 43.

### Second Embodiment

As shown in FIG. 16, in a liquid crystal display apparatus 1 according to a second embodiment of the present invention, an adhesive that cures by being irradiated with activation energy is used as the adhesive layer 42.

Specifically, for example, a photo-curing adhesive or a thermosetting adhesive can be suitably used as such an adhesive. In this embodiment, after applying such an adhesive onto the surface of the second polarization plate 5 of the liquid crystal display body 6, the adhesive is irradiated with ultraviolet light (UV light) or is heated, thereby forming the adhesive layer 42 in a semi-solid state. Then, after bonding the light diffusing member 7 to the second polarization plate 5 via this adhesive layer 42 in the semi-solid state, the light irradiation process or the heating process is further performed, thereby causing the adhesive layer 42 to cure.

In the liquid crystal display apparatus 1 according to this embodiment, such an adhesive that cures by being irradiated with activation energy is used as the adhesive layer 42 so that when the light diffusing member 7 is bonded to the liquid crystal display body 6, deterioration of the light diffusing function of the light diffusing member 7 can be suppressed while suppressing intrusion of the adhesive layer 42 into the space 43. Therefore, in the liquid crystal display apparatus 1 according to this embodiment, the light utilization efficiency can be enhanced, and good viewing-angle characteristics can be obtained.

Furthermore, the use of an adhesive that cures by being irradiated with activation energy as the adhesive layer 42 not only allows the thickness D of the adhesive layer 42 to be smaller than the height T of the space 43 (T>D), but also allows a sufficient thickness of the adhesive layer 42 to be ensured for bonding the light diffusing member 7 to the second polarization plate 5.

Furthermore, the material used as the adhesive layer 42 desirably has low affinity with the material of the light diffusers 40 so as to suppress intrusion of the adhesive layer 42 into the space 43.

### Third Embodiment

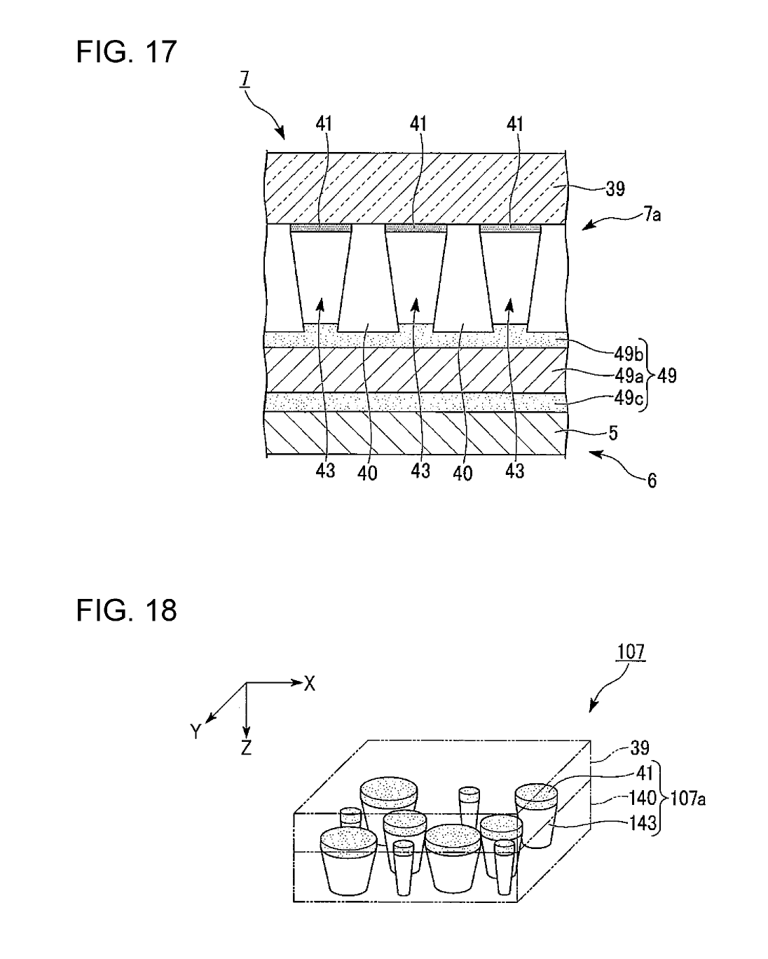

As shown in FIG. 17, in a liquid crystal display apparatus 1 according to a third embodiment of the present invention, an adhesive sheet 49 is used in place of the above-described adhesive layer 42. Specifically, the adhesive sheet 49 has a base 49a having light transmissivity and adhesive layers 49b and 49c formed on opposite surfaces of the base 49a. The base 49a used may be identical to the base 39. Moreover, the adhesive layers 49b and 49c used may be identical to the above-described adhesive layer 42.

In this embodiment, the light diffusing member 7 is bonded to the second polarization plate 5 with such an adhesive sheet 49 interposed therebetween. In this case, the thickness of the adhesive layer 49b, to which the light diffusing member 7 is to be bonded, of the adhesive sheet 49 and the thickness of the adhesive layer 49c, to which the second polarization plate 5 is to be bonded, of the adhesive sheet 49 can be reduced. Moreover, the rigidity of the adhesive sheet 49 when the light diffusing member 7 is pressure-bonded can be ensured with the base 49a having a higher elastic coefficient than the adhesive layers 49b and 49c.

In the liquid crystal display apparatus 1 according to this embodiment, such an adhesive sheet 49 is used so that when the light diffusing member 7 is bonded to the liquid crystal display body 6, deterioration of the light diffusing function of the light diffusing member 7 can be suppressed while suppressing intrusion of the adhesive layer 49b into the space 43. Therefore, in the liquid crystal display apparatus 1 according to this embodiment, the light utilization efficiency can be enhanced, and good viewing-angle characteristics can be obtained.

(Another Configuration Example of Light Diffusing Member)

Next, another configuration example of the light diffusing member included in the above-described liquid crystal display apparatus 1 will be described.

In the following description, descriptions of sections identical to those in the above-described liquid crystal display apparatus 1 and the above-described light diffusing member 7 will be omitted, and the same reference signs will be given thereto in the drawings.

[First Configuration Example]

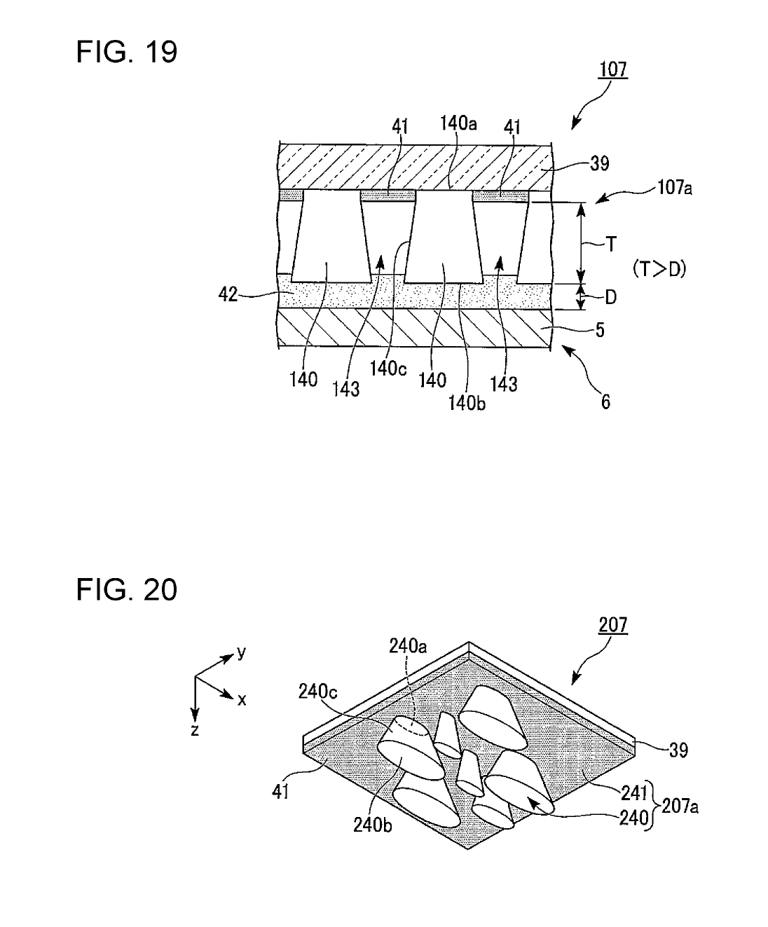

First, a light diffusing member 107 shown in FIGS. 18 and 19 will be described as a first configuration example.

FIG. 18 is a perspective view illustrating the configuration of the light diffusing member 107. FIG. 19 is a cross-sectional view illustrating the configuration of the light diffusing member 107.

The light diffusing member 107 has a configuration in which the regions where the light diffusers 40 and the light blocking layer 41 included in the above-described light diffusing member 7 are formed are inverted. Specifically, as shown in FIGS. 18 and 19, the light diffusing member 107 schematically includes a base 39 and a light control layer 107a formed on one surface (i.e., the surface opposite the viewing side) of the base 39.

The light control layer 107a diffuses light from the liquid crystal panel 4 and controls the light output direction, and is constituted of a plurality of light blocking layers 41 formed on the one surface of the base 39, a light diffuser 140 formed in a region other than the regions where the light blocking layers 41 are formed on the one surface of the base 39, and hollow sections 143 formed in the regions where the light blocking layers 41 are formed on the one surface of the base 39.

The plurality of light blocking layers 41 are arranged in a scattered manner, as viewed from the direction of the normal to the one surface of the base 39. The light diffuser 140 is formed continuously in the region other than the regions where the light blocking layers 41 are formed. The plurality of light blocking layers 41 are randomly (non-periodically) arranged as viewed from the direction of the normal to the principal surface of the base 39. The plurality of hollow sections 143 formed at positions corresponding to the plurality of light blocking layers 41 are also randomly arranged on the base 39.

The distance (i.e., the pitch) between the light blocking layers 41 is desirably smaller than the distance between the pixels of the liquid crystal panel 4. Thus, at least one light blocking layer 41 is formed within each pixel, so that a wide viewing angle can be achieved when the light diffusing member 107 is combined with a liquid crystal panel having a small pixel pitch used in, for example, a mobile device.

Each hollow section 143 has a circular shape in cross section taken along a horizontal plane (x-y plane), and a surface thereof at the base-39 side has a large area whereas a surface opposite the base 39 has a small area, such that the horizontal cross-sectional area gradually decreases from the base-39 side toward the side opposite the base 39. In other words, each hollow section 143 has a circular truncated cone shape with a side surface that is tapered when viewed from the base-39 side.

The interior of each hollow section 143 is a space in which an air layer exists. The light diffuser 140 is constituted of a section other than the hollow sections 143. The light diffuser 140 is a section that contributes to transmission of light and is composed of continuous transparent resin.

Of two opposite surfaces of the light diffuser 140, the surface with the smaller area (i.e., the surface in contact with the base 39) serves as a light exit end surface 140a and the surface with the larger area (i.e., the surface opposite the base 39) serves as a light entrance end surface 140b.

In the light diffusing member 107, since an air layer (i.e., hollow section 143) intervenes neighboring light diffusers 140, if the light diffuser 140 is composed of, for example, acrylic resin, each side surface 140c of the light diffuser 140 serves as an interface between the acrylic resin and the air layer. Thus, light entering the light diffuser 140 is optically guided in a substantially confined state inside the light diffuser 140 while undergoing total reflection at the interface between the light diffuser 140 and each hollow section 143, and is output outside via the base 39.

Therefore, in the light diffusing member 107, the critical angle is minimized due to Snell's law, and the incident-angle range in which undergoes total reflection at each side surface 140c of the light diffuser 140 is wide. As a result, loss of light is further suppressed, and high brightness can be obtained.

It is desirable that the refractive indices of the base 39 and the light diffuser 140 be substantially equal to each other. If the refractive indices largely differ from each other, for example, undesired light refraction or reflection occurs at the interface between the light diffuser 140 and the base 39 when the light entering from the light entrance end surface 140b is to enter the base 39 from the light diffuser 140. In other words, although there is a possibility of the occurrence of problems, such as an inability to obtain a desired light diffusion angle or a reduced quality of output light, the occurrence of such problems can be prevented by setting the refractive indices substantially equal to each other, as described above.

Alternatively, in the light diffusing member 107, in order to allow for total reflection of light, the surrounding region of the light diffuser 140 may be set in a low-refractive-index state, and each hollow section 143 may be filled with inert gas, such as nitrogen, in place of the air layer. As another alternative, each hollow section 143 may be set in a vacuum state or in a state where the pressure therein is lower than the atmospheric pressure.

The light diffusing member 107 having the above-described configuration is similar to the above-described light diffusing member 7 in that the liquid crystal display body 6 is disposed at the viewing side. Specifically, the light diffuser 140 is bonded to the second polarization plate 5 via the adhesive layer 42 or the adhesive sheet 49 in a state where the other surface of the base 39 is oriented toward the viewing side.

In the case where the liquid crystal display apparatus 1 is equipped with the light diffusing member 107 in place of the above-described light diffusing member 7, advantages similar to those of the first to third embodiments described above can be achieved with a configuration similar thereto. Specifically, when bonding the light diffusing member 107 to the liquid crystal display body 6, the thickness D of the adhesive layer 42 is preferably smaller than the height T of each hollow section 143, which is formed between the light diffuser 140 and the corresponding light blocking layer 41, from the light blocking layer 41 to the light entrance end surface 140b, as in the first embodiment described above. Furthermore, an adhesive that cures by being irradiated with activation energy is preferably used as the adhesive layer 42, as in the second embodiment described above. Moreover, the light diffusing member 107 is preferably bonded to the second polarization plate 5 with the adhesive sheet 49 interposed therebetween, as in the third embodiment described above.

Consequently, when the light diffusing member 107 is bonded to the liquid crystal display body 6, deterioration of the light diffusing function of the light diffusing member 107 can be suppressed while suppressing intrusion of the adhesive layer 42 or the adhesive layer 49b of the adhesive sheet 49 into the hollow sections 143. Therefore, in the liquid crystal display apparatus 1 equipped with such a light diffusing member 107, the light utilization efficiency can be enhanced, and good viewing-angle characteristics can be obtained.

[Second Configuration Example]

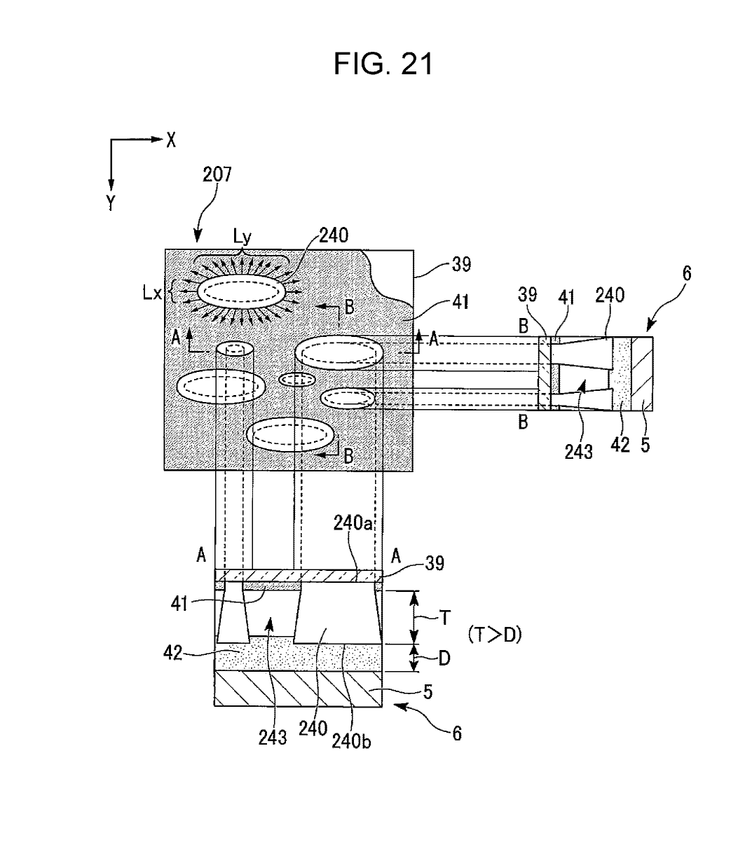

Next, a light diffusing member 207 shown in FIGS. 20 and 21 will be described as a second configuration example.

FIG. 20 is a perspective view illustrating the configuration of the light diffusing member 207. FIG. 21 schematically illustrates the configuration of the light diffusing member 207. An upper left part in FIG. 21 is a plan view of the light diffusing member 207, a lower left part in FIG. 21 is a cross-sectional view of the light diffusing member 207 taken along line A-A, and an upper right part in FIG. 21 is a cross-sectional view of the light diffusing member 207 taken along line B-B.

The light diffusing member 207 is obtained by changing the shape of the light diffusers 40 included in the above-described light diffusing member 7 from the circular truncated cone shape having no azimuthal anisotropy to an elliptical truncated cone shape having azimuthal anisotropy. Specifically, as shown in FIGS. 20 and 21, the light diffusing member 207 schematically includes a base 39 and a light control layer 207a formed on one surface (i.e., the surface opposite the viewing side) of the base 39. The light control layer 207a diffuses light from the liquid crystal panel 4 and controls the light output direction, and is constituted of a plurality of light diffusers 240 formed on the one surface of the base 39 and a light blocking layer 41.

The plurality of light diffusers 240 are arranged in a scattered manner on the one surface of the base 39. The planar shape of each light diffuser 240 as viewed from the direction of the normal to the base 39 is a long elliptical shape having a long axis and a short axis. In this embodiment, light diffusers 240 of different sizes are arranged in a scattered manner but have substantially the same ratio of the length along the long axis to the length along the short axis of each light diffuser 240. The plurality of light diffusers 240 are not limited to the type having different sizes and may be of a type having the same size.

In each light diffuser 240, a light exit end surface 240a thereof at the base-39 side has a small area whereas a light entrance end surface 240b thereof opposite the base 39 has a large area, such that the horizontal cross-sectional area gradually increases from the base-39 side toward the side opposite the base 39. Therefore, each light diffuser 240 has an elliptical truncated cone shape with a side surface 240c that is inversely tapered from the base-39 side toward the side opposite the base 39. The light blocking layer 41 is provided continuously in a region other than the plurality of light diffusers 240 on the one surface of the base 39. Therefore, a space 43 is formed between the light diffusers 240 and the light blocking layer 41, and an air layer exists in this space 43.

In the light diffusing member 207, the long axes of the elliptical planar shapes of the light diffusers 240 are substantially aligned in an X direction. On the other hand, the short axes of the elliptical planar shapes of the light diffusers 240 are substantially aligned in a Y direction. Therefore, in view of the orientation of the side surface 240c of each light diffuser 240, the proportion of the area of the side surface 240c in the X direction is larger than the proportion of the area of the side surface 240c in the Y direction in the side surface 240c of the light diffuser 240. Thus, the quantity of light Ly diffused in the Y direction by being reflected at the side surface 240c extending in the X direction is larger than the quantity of light Lx diffused in the X direction by being reflected at the side surface 240c extending in the Y direction.

Consequently, this light diffusing member 207 has azimuth anisotropy that causes light to be anisotropically diffused. In the side surface 240c formed between the light exit end surface 240a and the light entrance end surface 240b, the light diffusing power is relatively higher in the direction corresponding to the smaller area than in the direction corresponding to the larger area. In other words, the light diffusing member 207 has strong azimuth anisotropy in the Y direction. This direction in which the azimuth anisotropy is relatively stronger will be referred to as “azimuth direction” hereinafter.

The light diffusing member 207 having the above-described configuration is similar to the above-described light diffusing member 7 in that the liquid crystal display body 6 is disposed at the viewing side. Specifically, the light diffusers 240 are bonded to the second polarization plate 5 via the adhesive layer 42 or the adhesive sheet 49 in a state where the other surface of the base 39 is oriented toward the viewing side.

In the case where the liquid crystal display apparatus 1 is equipped with the light diffusing member 207 in place of the above-described light diffusing member 7, advantages similar to those of the first to third embodiments described above can be achieved with a configuration similar thereto. Specifically, when bonding the light diffusing member 207 to the liquid crystal display body 6, the thickness D of the adhesive layer 42 is preferably smaller than the height T of each hollow section 143, which is formed between the light diffuser 240 and the corresponding light blocking layer 41, from the light blocking layer 41 to the light entrance end surface 240b, as in the first embodiment described above. Furthermore, an adhesive that cures by being irradiated with activation energy is preferably used as the adhesive layer 42, as in the second embodiment described above. Moreover, the light diffusing member 207 is preferably bonded to the second polarization plate 5 with the adhesive sheet 49 interposed therebetween, as in the third embodiment described above.

Consequently, when the light diffusing member 207 is bonded to the liquid crystal display body 6, deterioration of the light diffusing function of the light diffusing member 207 can be suppressed while suppressing intrusion of the adhesive layer 42 or the adhesive layer 49b of the adhesive sheet 49 into the space 43. Therefore, in the liquid crystal display apparatus 1 equipped with such a light diffusing member 207, the light utilization efficiency can be enhanced, and good viewing-angle characteristics can be obtained.

Furthermore, in the light diffusing member 207, the azimuth direction of each light diffuser 240 is aligned with the direction for improving the viewing-angle characteristics in the liquid crystal panel 4. In this embodiment, since the direction for improving the viewing-angle characteristics in the liquid crystal panel 4 is the Y direction, the Y direction and the azimuth direction of the light diffusing member 207 are aligned with each other. Consequently, light can be properly diffused in the direction for improving the viewing-angle characteristics in the liquid crystal panel 4, so that a bright image with excellent viewability can be displayed.

The azimuth direction of the light diffusing member 207 is not limited to the aforementioned Y direction and may be appropriately changed in accordance with the direction for improving the viewing-angle characteristics in the liquid crystal panel 4.

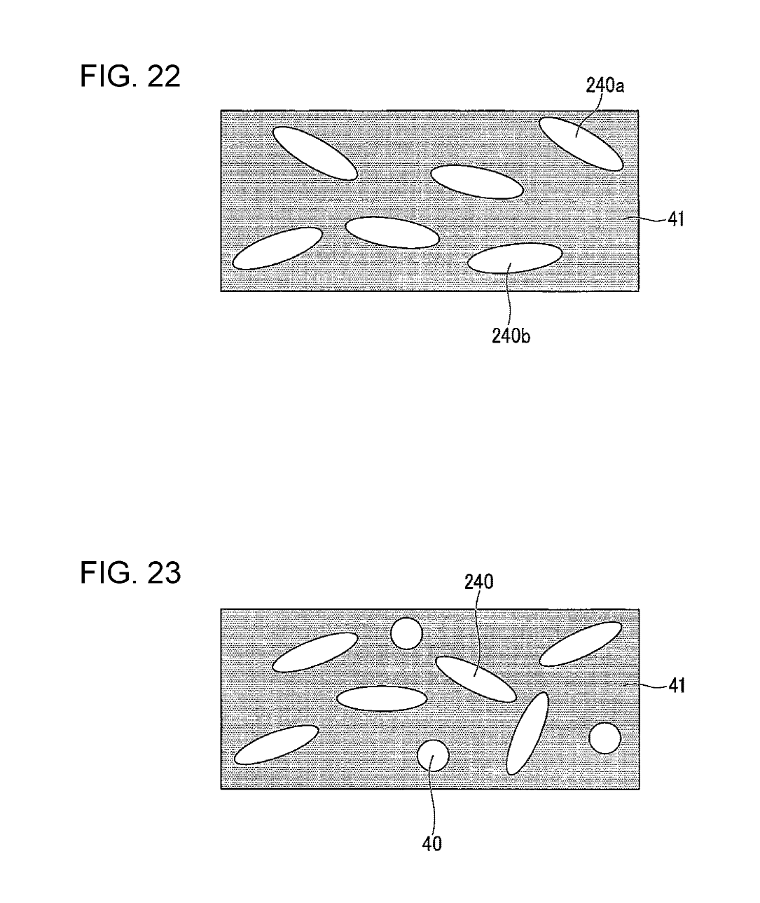

Furthermore, the light diffusing member 207 is not limited to the configuration in which the azimuth directions of the aforementioned light diffusers 240 are aligned in one direction. For example, as shown in FIG. 22, the light diffusing member 207 may have light diffusers 240a and 240b with different azimuth directions of azimuthal anisotropy. In this case, by varying the azimuth directions of azimuthal anisotropy, the direction for improving the viewing-angle characteristics in the liquid crystal panel 4 can be diversified.

Furthermore, the liquid crystal display apparatus 1 is not limited to the configuration with the above-described light diffusing member 7 or 207. For example, as shown in FIG. 23, the liquid crystal display apparatus 1 may be equipped with a light diffusing member having a mixture of the circular light diffusers 40 and the elliptical light diffusers 240 described above. Moreover, the shape of the light diffuser 40 or 240 is not limited to the circular or elliptical shape and may be a symmetrical or asymmetrical polygonal shape.

[Third Configuration Example]

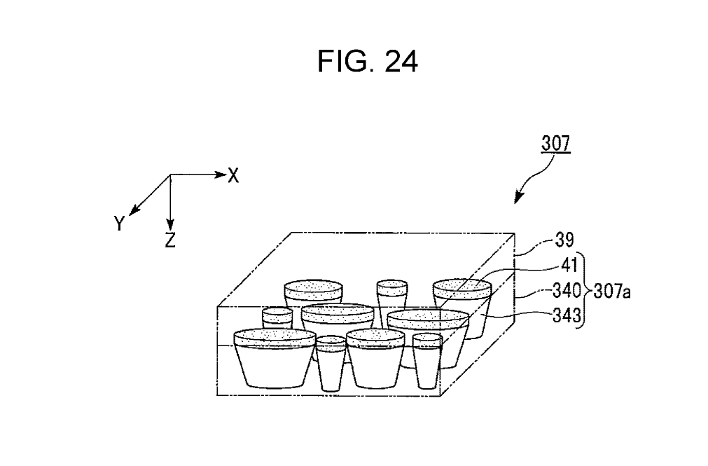

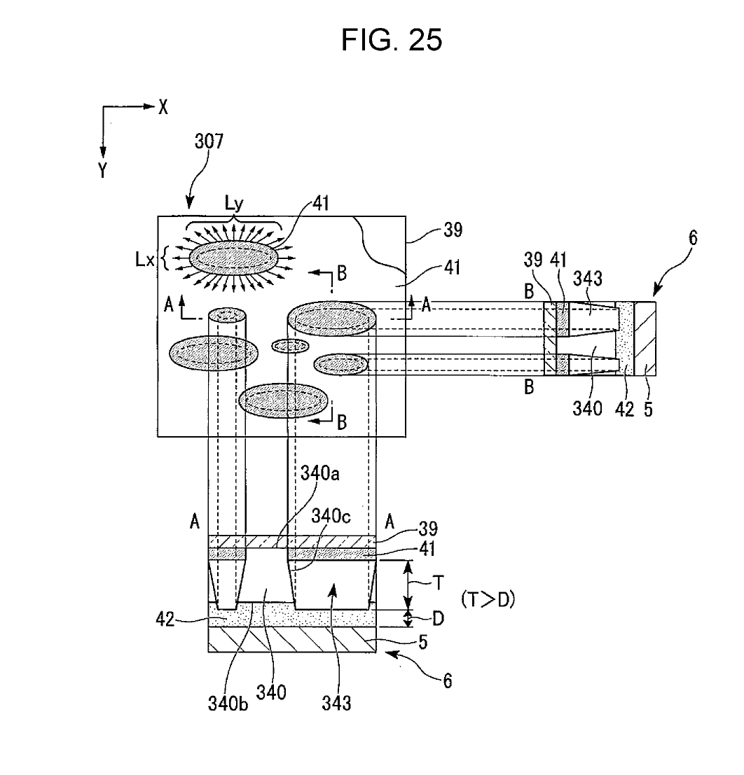

Next, a light diffusing member 307 shown in FIGS. 24 and 25 will be described as a second configuration example.

FIG. 24 is a perspective view illustrating the configuration of the light diffusing member 307. FIG. 25 schematically illustrates the configuration of the light diffusing member 307. An upper left part in FIG. 25 is a plan view of the light diffusing member 307, a lower left part in FIG. 25 is a cross-sectional view of the light diffusing member 307 taken along line A-A, and an upper right part in FIG. 25 is a cross-sectional view of the light diffusing member 307 taken along line B-B.

The light diffusing member 307 has a configuration in which the regions where the light diffusers 240 and the light blocking layer 41 included in the above-described light diffusing member 207 are formed are inverted. Specifically, as shown in FIGS. 24 and 25, the light diffusing member 307 schematically includes a base 39 and a light control layer 307a formed on one surface (i.e., the surface opposite the viewing side) of the base 39. The light control layer 307a diffuses light from the liquid crystal panel 4 and controls the light output direction, and is constituted of a plurality of light blocking layers 41 formed on the one surface of the base 39, a light diffuser 340 formed in a region other than the regions where the light blocking layers 41 are formed on the one surface of the base 39, and hollow sections 343 formed in the regions where the light blocking layers 41 are formed on the one surface of the base 39.

The plurality of light blocking layers 41 are arranged in a scattered manner, as viewed from the direction of the normal to the one surface of the base 39. The light diffuser 140 is formed continuously in the region other than the regions where the light blocking layers 41 are formed. The plurality of light blocking layers 41 are randomly (non-periodically) arranged as viewed from the direction of the normal to the principal surface of the base 39. The plurality of hollow sections 343 formed at positions corresponding to the plurality of light blocking layers 41 are also randomly arranged on the base 39.

The distance (i.e., the pitch) between the light blocking layers 41 is desirably smaller than the distance between the pixels of the liquid crystal panel 4. Thus, at least one light blocking layer 41 is formed within each pixel, so that a wide viewing angle can be achieved when the light diffusing member 307 is combined with a liquid crystal panel having a small pixel pitch used in, for example, a mobile device.

Each hollow section 343 has an elliptical shape in cross section taken along a horizontal plane (x-y plane), and a surface thereof at the base-39 side has a large area whereas a surface opposite the base 39 has a small area, such that the horizontal cross-sectional area gradually decreases from the base-39 side toward the side opposite the base 39. In other words, each hollow section 343 has an elliptical truncated cone shape with a side surface that is tapered when viewed from the base-39 side. In this embodiment, hollow sections 343 of different sizes are arranged in a scattered manner but have substantially the same ratio of the length along the long axis to the length along the short axis of each hollow section 343. The plurality of hollow sections 343 are not limited to the type having different sizes and may be of a type having the same size.

The interior of each hollow section 343 is a space in which an air layer exists. The light diffuser 340 is constituted of an area other than the hollow sections 343. The light diffuser 340 is a section that contributes to transmission of light and is composed of continuous transparent resin.

Of two opposite surfaces of the light diffuser 340, the surface with the smaller area (i.e., the surface in contact with the base 39) serves as a light exit end surface 340a and the surface with the larger area (i.e., the surface opposite the base 39) serves as a light entrance end surface 340b.

In the light diffusing member 307, since an air layer (i.e., hollow section 343) intervenes neighboring light diffusers 340, if the light diffuser 340 is composed of, for example, acrylic resin, each side surface 340c of the light diffuser 340 serves as an interface between the acrylic resin and the air layer. Thus, light entering the light diffuser 340 is optically guided in a substantially confined state inside the light diffuser 340 while undergoing total reflection at the interface between the light diffuser 340 and each hollow section 343, and is output outside via the base 39.

Therefore, in the light diffusing member 307, the critical angle is minimized due to Snell's law, and the incident-angle range in which light undergoes total reflection at the side surface 140c of the light diffuser 340 is wide. As a result, loss of light is further suppressed, and high brightness can be obtained.

It is desirable that the refractive indices of the base 39 and the light diffuser 340 be substantially equal to each other. If the refractive indices largely differ from each other, for example, undesired light refraction or reflection occurs at the interface between the light diffuser 340 and the base 39 when the light entering from the light entrance end surface 340b is to enter the base 39 from the light diffuser 340. In other words, although there is a possibility of the occurrence of problems, such as an inability to obtain a desired light diffusion angle or a reduced quality of output light, the occurrence of such problems can be prevented by setting the refractive indices substantially equal to each other, as described above.

Alternatively, in the light diffusing member 307, in order to allow for total reflection of light, the surrounding region of the light diffuser 340 may be set in a low-refractive-index state, and each hollow section 343 may be filled with inert gas, such as nitrogen, in place of the air layer. As another alternative, each hollow section 343 may be set in a vacuum state or in a state where the pressure therein is lower than the atmospheric pressure.

In the light diffusing member 307, the long axes of the elliptical planar shapes of the hollow sections 343 are substantially aligned in the X direction. On the other hand, the short axes of the elliptical planar shapes of the hollow sections 343 are substantially aligned in the Y direction. Therefore, in view of the orientation of each side surface 340c of the light diffuser 340, the proportion of the side surface 340c in the X direction is larger than the proportion of the side surface 340c in the Y direction in the side surface 340c of the light diffuser 340. Thus, the quantity of light Ly diffused in the Y direction by being reflected at the side surface 340c extending in the X direction is larger than the quantity of light Lx diffused in the X direction by being reflected at the side surface 340c extending in the Y direction.

Consequently, this light diffusing member 307 has azimuth anisotropy that causes light to be anisotropically diffused. In the side surface 340c formed between the light exit end surface 340a and the light entrance end surface 340b, the light diffusing power is relatively higher in the direction corresponding to the smaller area than in the direction corresponding to the larger area. In other words, the light diffusing member 307 has strong azimuth anisotropy in the Y direction.

The light diffusing member 307 having the above-described configuration is similar to the above-described light diffusing member 7 in that the liquid crystal display body 6 is disposed at the viewing side. Specifically, the light diffuser 340 is bonded to the second polarization plate 5 via the adhesive layer 42 or the adhesive sheet 49 in a state where the other surface of the base 39 is oriented toward the viewing side.

In the case where the liquid crystal display apparatus 1 is equipped with the light diffusing member 307 in place of the above-described light diffusing member 7, advantages similar to those of the first to third embodiments described above can be achieved with a configuration similar thereto. Specifically, when bonding the light diffusing member 307 to the liquid crystal display body 6, the thickness D of the adhesive layer 42 is preferably smaller than the height T of each hollow section 343, which is formed between the light diffuser 340 and the corresponding light blocking layer 41, from the light blocking layer 41 to the light entrance end surface 340b, as in the first embodiment described above. Furthermore, an adhesive that cures by being irradiated with activation energy is preferably used as the adhesive layer 42, as in the second embodiment described above. Moreover, the light diffusing member 307 is preferably bonded to the second polarization plate 5 with the adhesive sheet 49 interposed therebetween, as in the third embodiment described above.

Consequently, when the light diffusing member 307 is bonded to the liquid crystal display body 6, deterioration of the light diffusing function of the light diffusing member 307 can be suppressed while suppressing intrusion of the adhesive layer 42 or the adhesive layer 49b of the adhesive sheet 49 into the space 43. Therefore, in the liquid crystal display apparatus 1 equipped with such a light diffusing member 307, the light utilization efficiency can be enhanced, and good viewing-angle characteristics can be obtained.

Furthermore, in the light diffusing member 307, the azimuth direction of the light diffuser 340 is aligned with the direction for improving the viewing-angle characteristics in the liquid crystal panel 4. In this embodiment, since the direction for improving the viewing-angle characteristics in the liquid crystal panel 4 is the Y direction, the Y direction and the azimuth direction of the light diffusing member 307 are aligned with each other. Consequently, light can be properly diffused in the direction for improving the viewing-angle characteristics in the liquid crystal panel 4, so that a bright image with excellent viewability can be displayed.

The azimuth direction of the light diffusing member 307 is not limited to the aforementioned Y direction and may be appropriately changed in accordance with the direction for improving the viewing-angle characteristics in the liquid crystal panel 4.

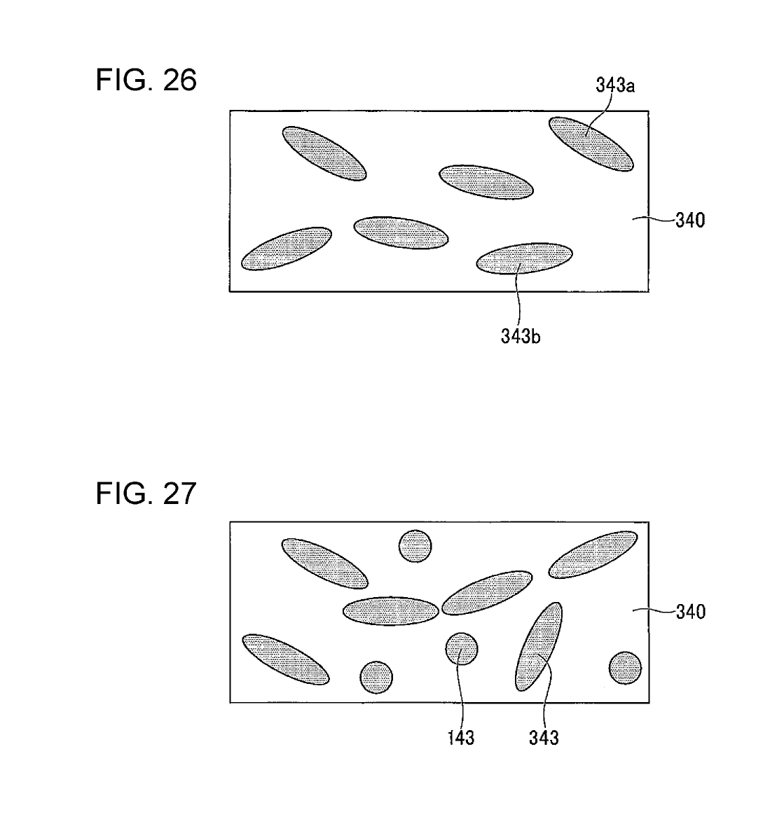

Furthermore, the light diffusing member 307 is not limited to the configuration in which the azimuth directions of the aforementioned hollow sections 343 are aligned in one direction. For example, as shown in FIG. 26, the light diffusing member 307 may have hollow sections 343a and 343b with different azimuth directions of azimuthal anisotropy. In this case, by varying the azimuth directions of azimuthal anisotropy, the direction for improving the viewing-angle characteristics in the liquid crystal panel 4 can be diversified.

Furthermore, the liquid crystal display apparatus 1 is not limited to the configuration with the above-described light diffusing member 107 or 307. For example, as shown in FIG. 27, the liquid crystal display apparatus 1 may be equipped with a light diffusing member having a mixture of the circular hollow sections 143 and the elliptical hollow sections 340 described above. Moreover, the shape of the hollow sections 143 or 343 is not limited to the circular or elliptical shape and may be a symmetrical or asymmetrical polygonal shape.

The present invention is not necessarily limited to the above-described embodiments, and various modifications may be added within a scope that does not depart from the spirit of the invention.

For example, although an example of a liquid crystal display apparatus equipped with the liquid crystal panel 4 as a display body is described in the above-described embodiments, the present invention is not limited to this example and may be applied to a display apparatus equipped with, for example, an organic electroluminescence (EL) element or a plasma display as the display body.

Furthermore, although an example in which the light diffusing member 7, 107, 207, or 307 is adhered on the second polarization plate 5 of the liquid crystal display body 6 is described in each of the above-described embodiments, the light diffusing member 7, 107, 207, or 307 and the liquid crystal display body 6 do not necessarily have to be in contact with each other. For example, another optical film or optical component may be inserted between the light diffusing member 7, 107, 207, or 307 and the liquid crystal display body 6. Alternatively, the light diffusing member 7, 107, 207, or 307 and the liquid crystal display body 6 may be located at positions distant from each other. Moreover, in the case of, for example, an organic electroluminescence display apparatus or a plasma display, a polarization plate is not necessary. Therefore, the light diffusing member 7, 107, 207, or 307 and the polarization plate will not come into contact with each other.

Furthermore, in each of the above-described embodiments, at least one of an antireflection layer, a polarization filter layer, an antistatic layer, an antiglare layer, and an antifouling layer may be provided at the viewing side of the base 39 in the light diffusing member 7, 107, 207, or 307. According to this configuration, for example, a function for reducing external-light reflection, a function for preventing adhesion of dust and stains, or a function for preventing scratches can be added, depending on the type of layer provided at the viewing side of the base 39, whereby the viewing-angle characteristics can be prevented from deteriorating with time.

Furthermore, although the light diffusers 40, 140, 240, and 340 in the above-described embodiments have a circular truncated cone shape or an elliptical truncated cone shape, the slope angles of the side surfaces 40c, 140c, 240c, and 340c of the light diffusers 40, 140, 240, and 340 do not necessarily have to be symmetrical with respect to the optical axis as the center. In the case where the light diffusers 40, 140, 240, and 340 have a circular truncated cone shape or an elliptical truncated cone shape as in the above-described embodiments, the slope angles of the side surfaces 40c, 140c, 240c, and 340c of the light diffusers 40, 140, 240, and 340 are symmetrical with respect to the optical axis as the center, so that symmetrical angle distribution can be obtained with respect to the optical axis as the center. In contrast, in a case where asymmetrical angle distribution is intentionally required in accordance with the purpose of the display apparatus or how the display apparatus is to be used, for example, if there is a demand for expanding the viewing angle at only the upper side or the right side of the screen, the slope angles of the side surfaces of the light diffusers 40, 140, 240, and 340 may be asymmetrical.

Specific configurations related to, for example, the dimensions and materials of the components in the light diffusing member and the manufacturing conditions in the manufacturing process therefor are not limited to those in the above-described embodiments and may be changed where appropriate.

### INDUSTRIAL APPLICABILITY

The present invention is applicable to various types of display apparatuses, such as a liquid crystal display apparatus, an organic electroluminescence display apparatus, and a plasma display.

### REFERENCE SIGNS LIST

1 liquid crystal display apparatus (display apparatus)
6 liquid crystal display body (display body)
7, 107, 207, 307 light diffusing member
39 base
40, 140, 240, 340 light diffuser
40a, 140a, 240a, 340a light exit end surface
40b, 140b, 240b, 340b light entrance end surface
40c, 140c, 240c, 340c side surface
41 light blocking layer
42 adhesive layer
43 space
143, 343 hollow section
49 adhesive sheet

1. A display apparatus comprising:
a display body;
a light diffusing member that is provided at a viewing side of the display body and that outputs light in a state where angle distribution of the light entering from the display body is expanded relative to that before the light enters the light diffusing member; and
an adhesive layer that is interposed between the display body and the light diffusing member,
wherein the light diffusing member includes a base having light transmissivity, a light diffuser formed with a predetermined height on a surface of the base facing the display body, and a light blocking layer formed in a region other than the light diffuser on the surface of the base facing the display body, the light blocking layer having a thickness smaller than the height of the light diffuser,
wherein the light diffuser has a light exit end surface that is in contact with the base, and a light entrance end surface that is opposite the light exit end surface and that has an area larger than an area of the light exit end surface,
wherein the light entrance end surface is adhered to the adhesive layer, and
wherein a thickness of the adhesive layer is smaller than a height of a space formed between the light diffuser and the light blocking layer, the height extending from the light blocking layer to the light entrance end surface.

2. A display apparatus comprising:
a display body;
a light diffusing member that is provided at a viewing side of the display body and that outputs light in a state where angle distribution of the light entering from the display body is expanded relative to that before the light enters the light diffusing member; and
an adhesive layer that is interposed between the display body and the light diffusing member,
wherein the light diffusing member includes a base having light transmissivity, a light diffuser formed with a predetermined height on a surface of the base facing the display body, and a light blocking layer formed in a region other than the light diffuser on the surface of the base facing the display body, the light blocking layer having a thickness smaller than the height of the light diffuser,
wherein the light diffuser has a light exit end surface that is in contact with the base, and a light entrance end surface that is opposite the light exit end surface and that has an area larger than an area of the light exit end surface,
wherein the light entrance end surface is adhered to the adhesive layer, and
wherein the adhesive layer is formed of an adhesive that cures by being irradiated with activation energy.

3. A display apparatus comprising:
a display body;
a light diffusing member that is provided at a viewing side of the display body and that outputs light in a state where angle distribution of the light entering from the display body is expanded relative to that before the light enters the light diffusing member; and
an adhesive sheet that is interposed between the display body and the light diffusing member,
wherein the adhesive sheet includes a base having light transmissivity and adhesive layers formed on opposite surfaces of the base,
wherein the light diffusing member includes a base having light transmissivity, a light diffuser formed with a predetermined height on a surface of the base facing the display body, and a light blocking layer formed in a region other than the light diffuser on the surface of the base facing the display body, the light blocking layer having a thickness smaller than the height of the light diffuser,
wherein the light diffuser has a light exit end surface that is in contact with the base, and a light entrance end surface that is opposite the light exit end surface and that has an area larger than an area of the light exit end surface, and
wherein the light entrance end surface is adhered to one of the adhesive layers of the adhesive sheet.

4. The display apparatus according to claim 1, wherein the light diffusing member has a side surface formed between the light exit end surface and the light entrance end surface of the light diffuser and has azimuthal anisotropy such that light diffusing power is relatively higher in a direction in which an area of the side surface is small than in a direction in which the area of the side surface is large.

5. The display apparatus according to claim 4, wherein the light diffusing member has light diffusers with different azimuth directions of the azimuthal anisotropy.

6. The display apparatus according to claim 1, wherein the light diffusing member has a plurality of light diffusers randomly arranged as viewed in a direction of normal to a principal surface of the base, and
wherein the light blocking layer is formed continuously in the region other than the light diffuser.

7. The display apparatus according to claim 1, wherein the light diffusing member has a plurality of light blocking layers randomly arranged as viewed in a direction of normal to a principal surface of the base, and
wherein the light diffuser is formed continuously in a region other than the light blocking layers.
